(19) United States
(12) Patent Application Publication
(10) Pub. No.: US 2009/0176037 A1
(43) Pub. Date: Jul. 9, 2009

(54) Thermoplastic film and method of producing the same

(75) Inventors: Masaaki Otoshi, Shizuoka (JP); Kiyokazu Hashimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/659,328

(22) PCT Filed: Jul. 27, 2005
(86) PCT No.: PCT/JP2005/014152

§ 371 Date: Feb. 5, 2007

(30) Foreign Application Priority Data
Aug. 4, 2004 (JP) 2004-228069

(51) Int. Cl. C09K 19/38; B29D 11/00

(52) U.S. Cl. 428/1.1; 264/1.34; 428/195.1

(57) ABSTRACT

A method of producing a thermoplastic film, which can increase uniformity of Re and Rth of a thermoplastic film obtained by stretching, and which can provide a thermoplastic film having few display irregularities when the film is incorporated into a liquid crystal display device as a retardation film, and a thermoplastic film produced by the method are provided. In a tenter, both ends in the width direction of the film are held with clips and the film is simultaneously stretched in the traveling direction A and the width direction B. By this, a thermoplastic film in which the number of adhesion marks is 10 marks/m2 or less, the in-plane retardation Re is 0 nm to 500 nm and the retardation Rth in the thickness direction is 30 nm to 500 nm is produced.

### TECHNICAL FIELD

The present invention relates to a thermoplastic film and a method of producing the same, and particularly to a thermoplastic film used for a liquid crystal display device and a method of producing the same.

### BACKGROUND ART

Conventionally, it has been practiced to extend viewing angles by stretching a thermoplastic film to generate in-plane retardation (Re) and retardation in the thickness direction (Rth), and using this film as a retardation film for a liquid crystal display.

Examples of methods of stretching a thermoplastic film include a method of stretching in the longitudinal (length) direction (longitudinal stretching), a method of stretching in the transverse (width) direction (transverse stretching) and a method of carrying out longitudinal stretching and transverse stretching sequentially (sequential biaxial stretching).

Of these, because of its compact equipment, longitudinal stretching has been mostly employed in the past. Generally, in the longitudinal stretching, a film is heated to the glass transition temperature (Tg) or higher on at least two pairs of nip rolls, and stretched in the longitudinal direction with setting the carrying rate of a nip roll on the exit side faster than that of a nip roll on the entrance side.

Japanese Patent Application Laid-Open No. 2002-311240 describes a method of longitudinal stretching of cellulose ester. According to Japanese Patent Application Laid-Open No. 2002-311240, by carrying out longitudinal stretching in the direction opposite to the direction of casting film, angle irregularities of the retarded phase axis can be improved.

Japanese Patent Application Laid-Open No. 2003-315551 describes a method of stretching in which nip rolls positioned with a small span of a length/width ratio (L/W) of 2 or less are provided in the stretching zone. According to Japanese Patent Application Laid-Open No. 2003-315551, the orientation in the thickness direction (Rth) can be improved.

Japanese Patent Application Laid-Open No. 2001-42130 describes a method of stretching a saturated norbornene film. According to Japanese Patent Application Laid-Open No. 2001-42130, by reducing temperature variations during stretching, fluctuation in Re can be decreased.

### DISCLOSURE OF THE INVENTION

However, using stretched films produced by the aforementioned conventional methods as a retardation film involves a problem of generation of minute display irregularities, and the films are therefore not suitable for crystal display devices.

Given this, the inventors of the present invention studied the cause of generation of display irregularities and it has been revealed that upon longitudinal stretching, stretching rolls produced surface failures such as scratch and adhesion marks in the film, and this results in display irregularities. In particular, when longitudinal stretching is carried out under a condition of a small length/width ratio (L/W<1) where the distance between stretching rolls (L) is small compared to the film width (W), adhesion failure is generated and display irregularities are easily caused. In this regard, the adhesion failure refers to a V-shaped mark (like a bird's toenail) of several mm found on the film surface. These marks are generated when the film is contacted and adhered to a stretching roll, and detached from the stretching roll, whereby the surface of a film is radially peeled from the adhered point. These marks are particularly noticeable when ) stretching at high temperatures. Such adhesion failure thus causes minute display irregularities when the film is incorporated into a liquid crystal display device.

Further, thermoplastic resin films produced by conventional methods had a problem that the Re and the Rth in the width direction are uneven and the films are not suitable for uses as optical films. This is because occurrence of necking differs at the end portions and the central portions of the film when longitudinal stretching is carried out, and longitudinal orientation is thus easier at the end portions than at the central portions.

The present invention has been made in view of such circumstances and aims at providing a method of producing a thermoplastic film, which can increase uniformity of Re and Rth of a thermoplastic film obtained by stretching, and which has few display irregularities when incorporated into a liquid crystal display device as a retardation film, and a thermoplastic film produced by the method.

To achieve the aforementioned objects, the first aspect of the present invention provides a method of producing a thermoplastic film including stretching a thermoplastic film, comprising the step of simultaneously stretching the film in the longitudinal direction and the transverse direction to produce a thermoplastic film having adhesion marks equal to or less than 10 marks/m², and having an in-plane retardation Re of 0 nm to 500 nm and a retardation Rth in the thickness direction of 30 nm to 500 nm.

According to the first aspect of the present invention, since stretching is simultaneously carried out in the longitudinal direction and the transverse direction, occurrence of in-plane unevenness in stretching can be prevented and uniform in-plane optical properties can be achieved. In addition, when stretching is simultaneously carried out in the longitudinal direction and the transverse direction, the number of adhesion marks produced in the stretching process can be decreased. Further, when stretching is simultaneously carried out in the longitudinal direction and the transverse direction, the stretching ratios in the longitudinal direction and the transverse direction are each randomly set and so the Re and the Rth can be controlled to desired values. Thus, according to the first aspect, a thermoplastic film excellent in optical properties in which the number of adhesion marks is 10 marks/m² or less, and which has an in-plane retardation Re of 0 nm to 500 nm and a retardation Rth in the thickness direction of 30 nm to 500 nm can be produced. Here, the adhesion mark refers to a V-shaped mark (like a bird's toenail) of several mm found on the film surface when the film is put on a black flat cloth and visually observed with reflected light under a tungsten lamp.

The second aspect of the present invention is a method according to the first aspect, wherein the stretching ratio in the longitudinal direction and the transverse direction is 1 to 2.5. When producing a thermoplastic film having optical properties of the first aspect, stretching at higher than 2.5 times may cause films to be broken when stretched.

The third aspect of the present invention is a method according to the first aspect, wherein the stretching ratio in one of the longitudinal direction and the transverse direction is 0.8 to 1.0 and the stretching ratio in the other direction is 1.0 to 2.5. This enables to produce a thermoplastic film shrunk in either the longitudinal direction or the transverse direction. By producing a film in this way, a thermoplastic film having a large Re can be produced.

The fourth aspect of the present invention is a method according to any one of the first to third aspects, further comprising the step of holding both ends of the film in the width direction with a clip during stretching of the film. Thus, according to the fourth aspect, the number of adhesion marks can be decreased and minute display irregularities generated when the film is incorporated into a liquid crystal display device can be decreased.

To achieve the aforementioned object, the fifth aspect of the present invention provides a thermoplastic film, wherein the film has following properties of: (A) adhesion marks equal to or less than 10 marks/m², (B) an in-plane retardation Re of 0 nm to 500 nm, and (C) a retardation Rth in the thickness direction of 30 nm to 500 nm. A thermoplastic film with such optical properties can be produced by the method described above.

The sixth aspect of the present invention is a thermoplastic film according to the fifth aspect, wherein the fluctuation in the retardation Re and the retardation Rth is 5% or less in the width direction and in the length direction. Thus, the film of the sixth aspect has uniform retardation and orientation angles in the width direction and the length direction, and unevenness in in-plane optical properties is extremely small.

The seventh aspect of the present invention is a thermoplastic film according to the fifth or sixth aspect, wherein the film is a cellulose acylate film or a norbornene resin film. Cellulose acylate films and norbornene resin films need not be crystallized after stretching, cause no trouble in the aforementioned method, and thus are particularly useful.

The eighth aspect of the present invention is a thermoplastic film according to the seventh aspect, wherein the cellulose acylate film satisfies a degree of substitution of acylate groups of 2.5≦A+B<3.0 and 1.25≦B<3.0 (A: degree of substitution of acetyl groups, B: total degree of substitution of propionyl groups, butyrate groups, pentanoyl groups and hexanoyl groups). Films satisfying this substitution degree have characteristics such as low melting point, being easily stretched and excellent in moisture proof properties. Further, since those films satisfying the substitution degree need not be crystallized, they cause no trouble in the aforementioned method, and thus are particularly useful.

The ninth aspect of the present invention is a polarizing plate comprising at least one layer of a cellulose acylate film according to the seventh or eighth aspect stacked therein.

The tenth aspect of the present invention is a compensation film for a liquid crystal display, comprising a cellulose acylate film according to the seventh or eighth aspect as a substrate.

The eleventh aspect of the present invention is an anti-reflection film comprising a cellulose acylate film according to the seventh or eighth aspect as a substrate.

According to the present invention, a thermoplastic film without fluctuation in Re or Rth or without display irregularities can be produced, and when the film is incorporated into a liquid crystal display device, uniform in-plane display can be achieved.

### BRIEF DESCRIPTION OF THE DRAWINGS

FIG. 1 is a plan view of a tenter for simultaneous biaxial stretching in the present invention;

FIG. 2 is a side view of the tenter of FIG. 1;

FIG. 3 is a side view of the tenter of FIG. 1;

FIGS. 4A to 4F are tables showing the results of Examples; and

FIGS. 5A to 5G are tables showing the results of Examples.

### DESCRIPTION OF THE SYMBOLS

2 tenter
3 film
5,6 rail
7,8 endless chain
10 clip
11,12 driving sprocket
13,14 driven sprockets
16 tenter entrance
17 tenter exit
21-24 release member
26 frame
27 film table
28 rotating lever
29 flapper

### BEST MODE FOR CARRYING OUT THE INVENTION

Preferred embodiments of the thermoplastic film and the method of producing the same of the present invention will now be described with reference to the attached figures.

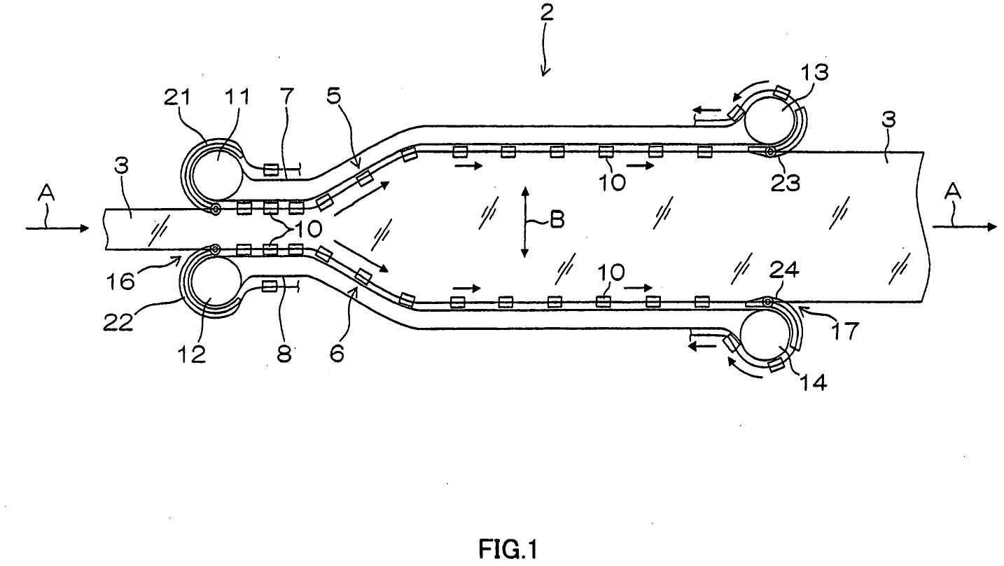

FIG. 1 is a plan view of a tenter for simultaneous biaxial stretching, which is a characteristic of the present invention. The tenter 2 illustrated in this figure is an apparatus which performs simultaneous stretching in the traveling direction A and the width direction B with transporting a film 3 in the traveling direction A, and the tenter 2 is equipped with two rails 5,6 and endless chains 7,8. The two rails 5,6 are positioned on both sides of the film 3 to sandwich the film 3, and the distance therebetween is designed so that the downstream side in the traveling direction A is broader than the upstream side.

The endless chains 7,8 are each put between driving sprockets 11,12 at the tenter entrance 16 and driven sprockets 13,14 at the tenter exit 17, and positioned so as to be guided by the rails 5,6. By activating the driving sprockets 11,12, the endless chains ) 7,8 travel along the course being guided by the rails 5,6.

The endless chains 7,8 have many clips 10,10 . . . at a pre-determined pitch which hold the side edges of the film 3. The clips 10 move along with the endless chains 7,8 as the endless chains 7,8 are run. The pitch between the clips 10 (the interval between clips 10,10 in the traveling direction A) is designed to vary as clips 10 move, so that the interval on the downstream side is broader than the interval on the upstream side in the traveling direction A. As a mechanism for changing the pitch of the clips 10, for example, a pantograph mechanism or a linear guide mechanism is used.

The aforementioned driving sprockets 11,12 are equipped with release members 21,22 and the driven sprockets 13, 14 are equipped with release members 23,24. The release members 21 to 24 are units for shifting the flappers 29 of the clip 10, which is described later, from the holding position to the releasing position, whereby holding and releasing of the film 3 by the flappers 29 are automatically carried out.

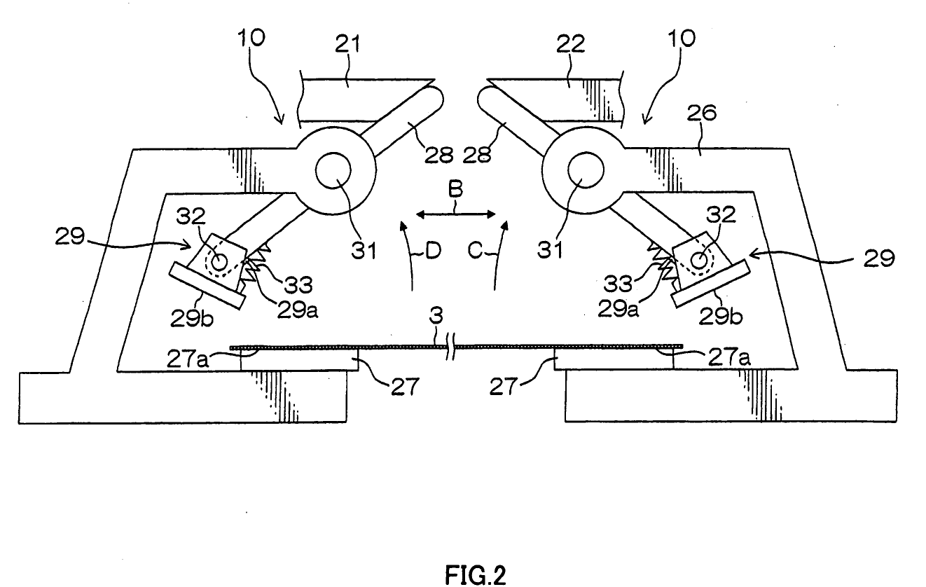

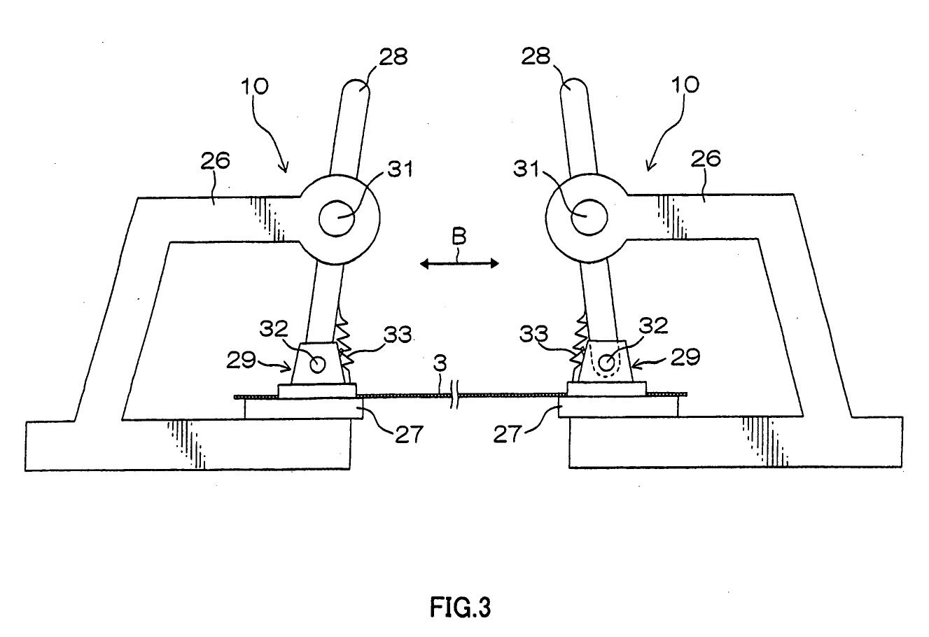

FIG. 2 and FIG. 3 are side views illustrating the structure of the clip 10, and FIG. 2 illustrates the clip 10 at the releasing position while FIG. 3 illustrates the clip 10 at the holding position.

As these figures show, the clip 10 is composed of a substantially U-shaped frame 26, a film table 27, a rotating lever 28 and a flapper 29. The flapper 29 is rotatably attached to the lower end of the rotating lever 28 via an attaching shaft 32. One end of a coil spring 33 is attached to the flapper 29, and the other end of the coil spring 33 is attached to the rotating lever 28. The coil spring 33 energizes the flapper 29 described on the right side in the figure in the direction of the arrow C and energizes the flapper 29 described on the left side in the figure in the direction of the arrow D. The flapper 29 has a projection 29a, and when the rotating lever 28 is rotated by energizing force from the coil spring 33, the projection 29a controls the rotation.

The rotating lever 28 is rotatably held by the frame 26 via an attaching shaft 31. The rotating lever 28 is normally positioned at the holding position by its own weight as shown in FIG. 3, and at this holding position, the table plane 27a of the film table 27 and the holding plane 29b of the flapper 29 hold the film 3. The rotating lever 28 is rotated as the upper edge thereof touches the release members 21 to 24 of FIG. 1, and according to this, the flapper 29 is moved upward and positioned to the releasing position where the film 3 is released as shown in FIG. 2.

In the tenter 2 as configured above, when the endless chains 7,8 are run and clips 10,10 . . . are transferred around, the flapper 29 of each clip 10 is set to the releasing position at the location of the release members 21,22, and upon passing through the release members 21,22, the flapper 29 is set to the holding position to hold both ends of the film 3. As for each clip 10 holding both ends of the film 3, when transferred in the traveling direction A, intervals between clips 10,10 are widened in the traveling direction A and the width direction B, whereby the film 3 is stretched simultaneously in the longitudinal direction and the transverse direction. When a clip 10 is transferred to the downstream in the traveling direction A, the flapper 29 of clip 10 is set to the releasing position by the release members 23,24, and the film 3 is released. The clip 10 from which the film 3 is released is returned to the release members 21,22 on the upstream side and holds the film 3 again to repeat the operation. By repeating such operation, the film 3 is stretched in the longitudinal direction and in the transverse direction to carry out simultaneous biaxial stretching.

In the step of simultaneous biaxial stretching, the stretching temperature is preferably not lower than Tg−10° C. and not higher than Tg+50° C., more preferably not lower than Tg and not higher than Tg+40° C., and further preferably not lower than Tg+2° C. and not higher than Tg+30° C. For heating the film 3, in addition to hot air, heating with a heater or microwave may be employed, or other heating means may be used.

In the aforementioned simultaneous biaxial stretching, the preferred stretching ratio is, in both the longitudinal and transverse directions, 0.8 to 2.5, more preferably 1.0 to 2.4, and further preferably 1.1 to 2.3. In this regard, when stretching is carried out at 0.8 to 1 times in either the longitudinal direction or the transverse direction, the stretching ratio in the other direction must be 1 to 2.5.

After simultaneous biaxial stretching, relaxation may be carried out in either or both the longitudinal direction and the transverse direction. According to this, the angle distribution of the retarded phase axis in the width direction can be narrowed. In the simultaneous biaxial stretching, the number of adhesion marks is preferably 10 marks/m² or less, more preferably 8 marks/m² or less, further preferably 5 marks/m² or less.

By stretching as described above, retardations Re and Rth can be generated. Re is preferably 0 nm to 500 nm, more preferably 10 to 400 nm, further preferably 15 nm to 300 nm. Rth is 30 nm to 500 nm, more preferably 50 nm to 400 nm, further preferably 70 nm to 350 nm. Of these, those satisfying Re≦Rth are preferred, and those satisfying Re×2≦Rth are more preferred. To achieve such high Rth and low Re, it is preferable to carry out biaxial stretching as described above. In other words, while the difference in orientations in the longitudinal direction and the transverse direction corresponds to in-plane retardation (Re), the difference in orientations in the longitudinal and the transverse directions can be made smaller and the in-plane orientation (Re) can be thus made smaller by stretching, in addition to the longitudinal direction, in the transverse direction which is perpendicular thereto. Further, because the area ratio is increased by stretching in the transverse direction in addition to the longitudinal direction, the orientation in the thickness direction is decreased along with decrease in the thickness, and the Rth can be increased.

Local fluctuation in Re and that in Rth in both the width direction and the length direction are preferably 5% or less, more preferably 4% or less, further preferably 3% or less.

Here, the retardations Re and Rth are calculated by the following formula.

Re(nm)=|n(MD)−n(TD)|×T(nm)

Rth(nm)=|{(n(MD)+n(TD))/2}−n(TH)|×T(nm)

In the formula, n(MD), n(TD) and n(TH) are the refractive index in the length direction, width direction and thickness direction, and T is thickness in nm.

The operation of this embodiment will now be described.

When biaxial stretching is carried out, a method in which longitudinal stretching is carried out followed by transverse stretching (sequential biaxial stretching) is common, and in the longitudinal stretching, the film is stretched in the traveling direction (longitudinal direction) using rolls of different speeds. However, such longitudinal stretching had a problem that orientation irregularity is caused in the width direction and in particular, orientation in the edge portions is higher than that in the central portions, and it was difficult to obtain a uniformly orientated film. In addition, longitudinal stretching using rolls involved a problem that surface failures such as scratch and adhesion marks are easily generated on the film.

Contrary to the above, in this embodiment, simultaneous biaxial orientation is carried out in the longitudinal direction and the transverse direction using the tenter 2. Accordingly, the aforementioned necking in the edge portions can be prevented and uniformity in the width direction can be achieved. By this, a thermoplastic film 3 having uniform in-plane optical properties can be produced.

Further, because longitudinal stretching and transverse stretching are carried out with the tenter 2 by holding the side edges of the film 3 with clips 10, adhesion marks can be decreased. As a result, minute display irregularities generated when incorporated into a liquid crystal display as a retardation film can be reduced. That effect is remarkable when a cellulose acylate film or a saturated norbornene film is used as a thermoplastic film. Because these resins tend to adhere to the nip roll used for stretching, the method of the present invention is very useful since adhesion marks can be decreased.

In addition, in this embodiment, the stretching ratios in the tenter 2 in the longitudinal direction and the transverse direction are each randomly set, and so Re and Rth can be controlled to any desired levels. Accordingly, a thermoplastic film with desired optical properties can be produced. For example, Re can be increased by increasing the difference between the stretching ratio in the longitudinal direction and the stretching ratio in the transverse direction, and Rth can be increased by increasing the stretching ratios in both directions. Further, the stretching ratio in either longitudinal stretching or transverse stretching may be set to 1 times or less, in other words, the film 3 may be shrunk in either the longitudinal direction or the transverse direction. According to this, Re and Rth can be determined within a broader range, and a thermoplastic film with desired optical properties can be thus obtained.

In the aforementioned embodiment, stretching is carried out with holding the edge portions of the film 3 with clips 10, but the method of simultaneous biaxial stretching is not limited to this. The method of operating clips 10 is not limited to mechanical (pantograph) type or linear motor type, and any method may be used.

As for the simultaneous biaxial stretching in the present invention, stretching in the longitudinal direction and stretching in the transverse direction are to be carried out substantially simultaneously, and may not be necessarily simultaneously started or simultaneously finished. Accordingly, as long as the film is stretched longitudinally and transversely with being held with clips 10 while being transferred, transverse ) stretching may be carried out after longitudinal stretching. Further, stretching in the present invention encompasses stretching at a stretching ratio of 1 times or less, that is, shrinking in one direction. Moreover, films used for simultaneous biaxial stretching may be an unstretched film or a uniaxially or biaxially pre-stretched film.

Resins, film-forming methods and film processing methods suitable for the present invention will now be described.

### (1) Thermoplastic Resin

The thermoplastic resin for the aforementioned stretching is not particularly limited, but preferred are cellulose acylate films and saturated norbornene films. These films are excellent as they have moderate Re/Rth expression upon stretching and less possibility of causing stretching irregularity. Cellulose acylate resins and saturated norbornene resins are described below.

### (Cellulose Acylate Resin)

The cellulose acylate used in the present invention preferably has the following characteristics. A cellulose acylate film in which acylate groups satisfy the following degree of substitution:

2.5≦A+B≦3.0 and

1.25≦B≦3.0 (A: degree of substitution of acetyl groups, B: the total degree of substitution of propionyl groups, butyrate groups, pentanoyl groups and hexanoyl groups). A more preferable substitution degree is, when at least ½ of B is a propionyl group,

2.6≦A+B≦2.95

2.0≦B<2.95

and when less than ½ of B is a propionyl group,

2.6≦A+B≦2.95

1.3≦B≦2.5. A further preferable substitution degree is, when at least ½ of B is a propionyl group,

2.7≦A+B≦2.95

2.4≦B≦2.9

and when less than ½ of B is a propionyl group,

2.7≦A+B≦2.95

1.3≦B≦2.0.

A characteristic of the present invention is that the degree of substitution of acetate groups is set to be low while the total degree of substitution of propionate groups, butyrate groups, pentanoyl groups and hexanoyl groups is set to be high. According to this, stretching irregularity is difficult to occur in the stretching process and Re/Rth irregularity is hardly generated, and in addition, the crystalline melting temperature (Tm) can be lowered and yellowing of film formed by melting occurring due to decomposition by heat can be prevented. These effects can be achieved by using as large a substituent as possible, but too large a substituent is not preferable because the glass transition temperature (Tg) or elasticity modulus is significantly reduced. For this reason, the substituent is preferably a propionate group, a butyrate group, a pentanoyl group or a hexanoyl group which is larger than an acetyl group, and more preferably a propionate group or a butyrate group, and further preferably a butyrate group.

Basic principles for synthesizing such cellulose acylate are described in Migita et al, Mokuzai Kagaku, p. 180 to 190 (published from Kyoritsu Shuppan Co., Ltd., 1968). A typical synthetic method is liquid-phase acetylation using carboxylic acid anhydride/acetic acid/a sulfuric acid catalyst. Specifically, after subjecting a cellulose raw material such as cotton linter or wood pulp to a pre-treatment with an appropriate amount of acetic acid, the material is poured into a previously cooled carboxylation mixture to be esterified, whereby a complete cellulose acylate is synthesized (the total of the acyl substitution degrees at the 2-, 3- and 6-positions being about 3.00). The carboxylation mixture generally contains acetic acid as a solvent, carboxylic acid anhydride as an esterification agent and sulfuric acid as a catalyst. Carboxylic acid anhydride is usually used in a stoichiometrically excessive amount over the total amount of cellulose which reacts with the anhydride and water present in the system. After completion of the acylation reaction, an aqueous solution of a neutralizing agent (e.g., carbonate, acetate or oxide of calcium, magnesium, iron, aluminum or zinc) is added thereto in order to hydrolyze excessive carboxylic acid anhydride remaining in the system and neutralize part of the esterifying catalyst remaining in the system. The obtained complete cellulose acylate is then kept at 50 to 90° C. in the presence of a small amount of an acetylation reaction catalyst, which is generally remaining sulfuric acid, thus saponified and ripened to be converted to cellulose acylate having a desired acyl substitution degree and polymerization degree. When the desired cellulose acylate is obtained, by completely neutralizing the catalyst remaining in the system with a neutralizing agent as described above, or without such neutralization, the cellulose acylate solution is poured into water or dilute sulfuric acid (or water or dilute sulfuric acid is poured into the cellulose acylate solution) to separate the cellulose acylate, followed by washing and stabilizing treatment to yield cellulose acylate.

The polymerization degree of cellulose acylate preferably used in the present invention is, in a viscosity average polymerization degree, 200 to 700, preferably 250 to 550, more preferably 250 to 400, particularly preferably 250 to 350. The average polymerization degree can be measured by a limiting viscosity method by Uda et al., (Kazuo Uda, Hideo Saito, Journal of the Society of Fiber Science and Technology, Japan, vol. 18, No. 1, 105-120, 1962). The method is described in detail in Japanese Patent Application Laid-Open No. 9-95538.

The polymerization degree can also be adjusted by removing low molecular weight components. When such low molecular weight components are removed, the average molecular weight (polymerization degree) is increased, but the viscosity effectively becomes lower than that of ordinary cellulose acylate. Low molecular weight components can be removed by washing cellulose acylate with an appropriate organic solvent. The molecular weight can also be adjusted by polymerization. For example, when producing cellulose acylate containing small amounts of low molecular weight components, the amount of the sulfuric acid catalyst in the acetylation reaction is preferably adjusted to 0.5 to 25 parts by mass based on 100 parts by mass of cellulose. By setting the amount of the sulfuric acid catalyst to this range, cellulose acylate having a preferable molecular weight distribution (uniform molecular weight distribution) can be synthesized.

As for cellulose acylate used in the present invention, those having a weight average molecular weight Mw/number average molecular weight Mn ratio of preferably 1.5 to 5.5, particularly preferably 2.0 to 5.0, more preferably 2.5 to 5.0, further preferably 3.0 to 5.0 are used.

These cellulose acylates may be used alone or in a mixture of two or more. A mixture in which a high molecular component other than cellulose acylate is accordingly mixed may also be used. As the high molecular component to be mixed, those having excellent compatibility with cellulose ester are preferred, and the transparency when formed into a film is preferably not less than 80%, more preferably not less than 90%, and further preferably not less than 92%.

In the present invention, by adding a plasticizer to cellulose acylate, the crystalline melting temperature (Tm) of cellulose acylate can be lowered. The molecular weight of the plasticizer used in the present invention is not particularly limited, and the plasticizer may be low molecular weight or high molecular weight. Examples of such plasticizer include phosphoric esters, alkyl phthalyl alkyl glycolates, carboxylic acid esters and polyol fatty acid esters. The plasticizer may be solid or oily substance. That is, the melting point and the boiling point of the plasticizer are not particularly limited. When melt film forming is carried out, a nonvolatile plasticizer is particularly preferably used.

Specific examples of phosphoric esters include triphenyl phosphate, tributyl phosphate, tributoxyethyl phosphate, tricresyl phosphate, trioctyl phosphate, trinaphthyl phosphate, trixylyl phosphate, tris-ortho-biphenyl phosphate, cresylphenyl phosphate, octyldiphenyl phosphate, biphenyldiphenyl phosphate and 1,4-phenylene-tetraphenyl phosphoric ester. In addition, a phosphoric ester plasticizer described in claims 3 to 7 of Japanese National Publication of International Patent Application No. 6-501040 may be used.

Examples of alkyl phthalyl alkyl glycolates include methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, octyl phthalyl ethyl glycolate.

Examples of carboxylic acid esters include phthalic acid esters such as dimethyl phthalate, diethyl phthalate, dibutyl phthalate, dioctyl phthalate and diethylhexyl phthalate, citric acid esters such as acetyl trimethyl citrate, acetyl triethyl citrate, acetyl tributyl citrate, adipic acid esters such as dimethyl adipate, dibutyl adipate, diisobutyl adipate, bis(2-ethylhexyl)adipate, diisodecyl adipate and bis(butyl diglycol)adipate, aromatic polyvalent carboxylic acid esters such as tetraoctyl pyromellitate and trioctyl trimellitate, aliphatic polyvalent carboxylic acid esters such as dibutyl adipate, dioctyl adipate, dibutyl sebacate, dioctyl sebacate, diethyl azelate, dibutyl azelate and dioctyl azelate, polyol fatty acid esters such as glycerol triacetate, diglycerol tetraacetate, acetylated glyceride, monoglyceride and diglyceride. In addition, butyl oleate, methylacetyl ricinoleate, dibutyl sebacate or triacetin may be used alone or in combination.

Additional examples of such plasticizer include high molecular weight plasticizers such as aliphatic polyesters composed of glycol and dibasic acid such as polyethylene adipate, polybutylene adipate, polyethylene succinate and polybutylene succinate, aliphatic polyesters composed of oxycarboxylic acid such as polylactic acid and polyglycolic acid, aliphatic polyesters composed of lactone such as polycaprolactone, polypropiolactone and polyvalerolactone, and vinyl polymers such as polyvinylpyrrolidone. These plasticizers may be used alone or together with a low molecular weight plasticizer.

Polyol plasticizers have good compatibility with cellulose fatty acid ester and exhibit apparent thermoplasticity-imparting effect, examples of which include glycerol ester compounds such as glycerol ester and diglycerol ester, polyalkylene glycols such as polyethylene glycol and polypropylene glycol and compounds in which an acyl group is bonded to a hydroxyl group of polyalkylene glycol.

Specific examples of glycerol esters include, but are not limited to, glycerine diacetate stearate, glycerine diacetate palmitate, glycerine diacetate mystirate, glycerine diacetate laurate, glycerine diacetate caprate, glycerine diacetate nonanate, glycerine diacetate octanoate, glycerine diacetate heptanoate, glycerine diacetate hexanoate, glycerine diacetate pentanoate, glycerine diacetate oleate, glycerine acetate dicaprate, glycerine acetate dinonanate, glycerine acetate dioctanoate, glycerine acetate diheptanoate, glycerine acetate dicaproate, glycerine acetate divalerate, glycerine acetate dibutyrate, glycerine dipropionate caprate, glycerine dipropionate laurate, glycerine dipropionate mystirate, glycerine dipropionate palmitate, glycerine dipropionate stearate, glycerine dipropionate oleate, glycerine tributyrate, glycerine tripentanoate, glycerine monopalmitate, glycerine monostearate, glycerine distearate, glycerine propionate laurate, glycerine oleate propionate. These can be used alone or in combination.

Of these, glycerine diacetate caprylate, glycerine diacetate pelargonate, glycerine diacetate caprate, glycerine diacetate laurate, glycerine diacetate myristate, glycerine diacetate palmitate, glycerine diacetate stearate, glycerine diacetate oleate are preferred.

Specific examples of diglycerol esters include, but are not limited to, mixed acid esters of diglycerol such as diglycerine tetraacetate, diglycerine tetrapropionate, diglycerine tetrabutyrate, diglycerine tetravalerate, diglycerine tetrahexanoate, diglycerine tetraheptanoate, diglycerine tetracaprylate, diglycerine tetrapelargonate, diglycerine tetracaprate, diglycerine tetralaurate, diglycerine tetramystirate, diglycerine tetrapalmitate, diglycerine triacetate propionate, diglycerine triacetate butyrate, diglycerine triacetate valerate, diglycerine triacetate hexanoate, diglycerine triacetate heptanoate, diglycerine triacetate caprylate, diglycerine triacetate pelargonate, diglycerine triacetate caprate, diglycerine triacetate laurate, diglycerine triacetate mystirate, diglycerine triacetate palmitate, diglycerine triacetate stearate, diglycerine triacetate oleate, diglycerine diacetate dipropionate, diglycerine diacetate dibutyrate, diglycerine diacetate divalerate, diglycerine diacetate dihexanoate, diglycerine diacetate diheptanoate, diglycerine diacetate dicaprylate, diglycerine diacetate dipelargonate, diglycerine diacetate dicaprate, diglycerine diacetate dilaurate, diglycerine diacetate dimystirate, diglycerine diacetate dipalmitate, diglycerine diacetate distearate, diglycerine diacetate dioleate, diglycerine acetate tripropionate, diglycerine acetate tributyrate, diglycerine acetate trivalerate, diglycerine acetate trihexanoate, diglycerine acetate triheptanoate, diglycerine acetate tricaprylate, diglycerine acetate tripelargonate, diglycerine acetate tricaprate, diglycerine acetate trilaurate, diglycerine acetate trimystirate, diglycerine acetate tripalmitate, diglycerine acetate tristearate, diglycerine acetate trioleate, diglycerine laurate, diglycerine stearate, diglycerine caprylate, diglycerine myristate, diglycerine oleate. These can be used alone or in combination.

Of these, diglycerol tetraacetate, diglycerol tetrapropionate, diglycerol tetrabutyrate, diglycerol tetracaprylate and diglycerol tetralaurate are preferred.

Specific examples of polyalkylene glycol include, but are not limited to, polyethylene glycol and polypropylene glycol having an average molecular weight of 200 to 1000, and these may be used alone or in combination.

Specific examples of compounds in which an acyl group is bonded to a hydroxyl group of polyalkylene glycol include, but are not limited to, polyoxyethylene acetate, polyoxyethylene propionate, polyoxyethylene butyrate, polyoxyethylene valyrate, polyoxyethylene caproate, polyoxyethylene heptanoate, polyoxyethylene octanoate, polyoxyethylene nonanate, polyoxyethylene caprate, polyoxyethylene laurate, polyoxyethylene myristilate, polyoxyethylene palmitate, polyoxyethylene stearate, polyoxyethylene oleate, polyoxyethylene linolate, polyoxypropylene acetate, polyoxypropylene propionate, polyoxypropylene butyrate, polyoxypropylene valyrate, polyoxypropylene caproate, polyoxypropylene heptanoate, polyoxypropylene octanoate, polyoxypropylene nonanate, polyoxypropylene caprate, polyoxypropylene laurate, polyoxypropylene myristilate, polyoxypropylene palmitate, polyoxypropylene stearate, polyoxypropylene oleate, polyoxypropylene linolate. These may be used alone or in combination.

The amount to be added of plasticizer is 0 to 20% by weight, more preferably 2 to 18% by weight, most preferably 4 to 15% by weight. When the content of the plasticizer is higher than 20% by weight, although the thermal flowability of cellulose acylate is improved, the plasticizer may bleed on the surface of the film formed by melting and the glass transition temperature Tg, which indicates heat resistance, may be decreased.

Further, where necessary, a stabilizer for preventing thermal degradation or coloring may be added to the cellulose acylate used in the present invention within the limit in which the required properties are not damaged.

As a stabilizer, a phosphite compound, a phosphorous acid ester compound, phosphate, thiophosphate, weak organic acid or an epoxy compound may be added alone, or two or more of them may be mixed to be added. As specific examples of phosphite stabilizers, the compounds described in paragraphs [0023] to [0039] of Japanese Patent Application Laid-Open No. 2004-182979 may be preferably used. As specific examples of phosphorous acid ester compounds, the compounds described in Japanese Patent Application Laid-Open Nos. 51-70316, 10-306175, 57-78431, 54-157159 and 55-13765 may be used.

The amount to be added of the stabilizer in the present invention is 0.005 to 0.5% by weight, more preferably 0.01 to 0.4% by weight, further preferably 0.05 to 0.3% by weight based on cellulose acylate. When the amount is less than 0.005% by weight, the effect of preventing degradation and coloring in the melt film forming process is insufficient, and this range is thus not preferable. When the amount is 0.5% or more, the stabilizer may bleed on the surface of the cellulose acylate film formed by melting, and this range is thus not preferable.

In addition, an antidegradant and an antioxidant may be preferably added. When a phenol compound, a thioether compound or a phosphorus compound is added as an antidegradant or an antioxidant, synergistic anti-degradation and anti-oxidant effect can be obtained. As other stabilizers, materials described in detail in “Kokai Giho of Japan Institute of Invention & Innovation” (Kogi No. 2001-1745, published Mar. 15, 2001, Japan Institute of Invention & Innovation), pp. 17-22 may be preferably used.

The cellulose acylate used in the present invention may contain an ultraviolet absorber, and one or more ultraviolet absorbers may be added. As an ultraviolet absorber for liquid crystal, preferred are those with excellent ability to absorb ultraviolet rays having a wavelength of 380 nm or less from the viewpoint of preventing degradation of liquid crystal and which absorb little visible light having a wavelength of 400 nm or more from the viewpoint of display properties of liquid crystal. Examples thereof include oxybenzophenone compounds, benzotriazole compounds, salicylic ester compounds, benzophenone compounds, cyanoacrylate compounds and nickel complex salt compounds. Particularly preferred ultraviolet absorbers include benzotriazole compounds and benzophenone compounds. Of these, benzotriazole compounds are preferred because unwanted coloring of cellulose acylate is small.

Preferred ultraviolet absorbers include 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tri(3,5-di-tert-butyl-4-hydroxybenzyl)benzene, tris-(3,5-di-tert-butyl-4-hydroxybenzyl)-isocyanurate.

In addition, 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate] are preferred. Further, a hydrazine metal deactivator such as N,N′-bis[3-(3,5-di-tert-butyl-4-hydroxyphenyl)propionyl]hydrazine or a phosphorus processing stabilizer such as tris(2,4-di-tert-butylphenyl)phosphite may be used together. The amount to be added of these compounds is preferably 1 ppm to 3.0% by mass, more preferably 10 ppm to 2% by mass based on cellulose ester, e.g., cellulose acylate.

As such ultraviolet absorbers, the following commercially available products may be used.

Examples of benzotriazole ultraviolet absorbers include TINUBIN P (Ciba Specialty Chemicals K.K.), TINUBIN 234 (Ciba Specialty Chemicals K.K.), TINUBIN 320 (Ciba Specialty Chemicals K.K.), TINUBIN 326 (Ciba Specialty Chemicals K.K.), TINUBIN 327 (Ciba Specialty Chemicals K.K.), TINUBIN 328 (Ciba Specialty Chemicals K.K.) and Sumisorb 340 (Sumitomo Chemical Co., Ltd.). Examples of benzophenone ultraviolet absorbers include Seesorb 100 (SHIPRO KASEI KAISHA LTD.), Seesorb 101 (SHIPRO KASEI KAISHA LTD.), Seesorb 101S (SHIPRO KASEI KAISHA LTD.), Seesorb 102 (SHIPRO KASEI KAISHA LTD.), Seesorb 103 (SHIPRO KASEI KAISHA LTD.), ADK STAB LA51 (ASAHI DENKA CO., LTD.), Chemisorp 111 (CHEMIPRO KASEI KAISHA LTD.) and UVINUL D-49 (BASF). Examples of oxalic acid anilide ultraviolet absorbers include TINUBIN 312 (Ciba Specialty Chemicals K.K.) and TINUBIN 315 (Ciba Specialty Chemicals K.K.). In addition, as salicylic acid ultraviolet absorbers, Seesorb 201 (SHIPRO KASEI KAISHA LTD.) and Seesorb 202 (SHIPRO KASEI KAISHA LTD.) are commercially available, and examples of cyanoacrylate ultraviolet absorbers include Seesorb 501 (SHIPRO KASEI KAISHA LTD.) and UVINUL N-539 (BASF).

### (Saturated Norbornene Resin)

Examples of saturated norbornene resins used in the present invention include (1) resins obtained by subjecting a (co)polymer of a norbornene monomer prepared by ring-opening polymerization to polymer modification such as addition of maleic acid or addition of cyclopentadiene according to need, followed by hydrogenation, (2) resins obtained by addition polymerization of a norbornene monomer and (3) resins obtained by addition copolymerization of a norbornene monomer and an olefin monomer such as ethylene or α-olefin. Polymerization and hydrogenation can be carried out according to a usual method.

Examples of norbornene monomer include norbornene, alkyl and/or alkylidene substituted type thereof such as 5-methyl-2-norbornene, 5-dimethyl-2-norbornene, 5-ethyl-2-norbornene, 5-butyl-2-norbornene, 5-ethylidene-2-norbornene, and polar group, e.g., halogen substituted type thereof; dicyclopentadiene and 2,3-dihydrodicyclopentadiene; dimethanooctahydronaphthalene, alkyl and/or alkylidene substituted type thereof and polar group, e.g., halogen substituted type thereof such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethylidene-1 ,4:5,8-dimethano-1,4,4a,5,6,7,8,8a-octahydronaphthalene, 6-chloro-1 ,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1 ,4:5,8-dimethano-1,4,4a,5,6,7,8,8a-octahydronaphthalene, 6-methoxycarbonyl-1,4:5,8-dimethano-1,4,4a,5,6,7,8,8a-octahydronaphthalene; an adduct of cyclopentadiene and tetrahydroindene; and cyclopentadiene tri- or tetramers, e.g., 4,9:5,8-dimethano-3a,4,4a,5,8,8a,9,9a-octahydro-1H-benzoindene, 4,11:5, 10:6,9-trimethano-3a,4,4a,5,5a,6,9,9a,10,10a, 11,11a-dodecahydro-1H-cyclopentaa nthracene.

In the present invention, other cycloolefins polymerizable by ring opening polymerization may be used together within the limit in which the object of the present invention is not damaged. Specific examples of such cycloolefins include compounds having a reactive double bond, such as cyclopentene, cyclooctene and 5,6-dihydrodicyclopentadiene.

The saturated norbornene resin used in the present invention has a number average molecular weight of usually 25000 to 100000, preferably 30000 to 80000, more preferably 35000 to 70000 as measured by gel permeation chromatography (GPC) using a toluene solvent. When the number average molecular weight is too small, the resin has a poor mechanical strength, and when it is too large, operationability in molding becomes poor.

In the present invention, the saturated norbornene resin has a glass transition ) temperature (Tg) of preferably not lower than 100° C. and not higher than 250° C., more preferably not lower than 115° C. and not higher than 220° C., further preferably not lower than 130° C. and not higher than 200° C.

Where desired, additives such as a phenol or phosphorus antioxidant, an antistatic agent or an ultraviolet absorber may be added to the thermoplastic saturated norbornene resin used in the present invention. In particular, since liquid crystal is usually degraded by ultraviolet light, an ultraviolet absorber may be added in the case where no other protective means such as laminating a UV protection filter is taken. As such ultraviolet absorber, benzophenone ultraviolet absorbers, benzotriazole ultraviolet absorbers and acrylonitrile ultraviolet absorbers may be used, and of these, benzophenone ultraviolet absorbers are preferred, which are to be added in an amount of usually 10 to 100000 ppm, preferably 100 to 10000 ppm. Further, when preparing a sheet by solvent casting, a leveling agent is preferably added in order to reduce surface roughness. As such leveling agent, for example, fluorine nonionic surfactants and leveling agents for coating such as special acrylic resin leveling agent and silicone leveling agent may be used. Of these, those highly compatible with solvent is preferred, and the amount to be added of the leveling agent is usually 5 to 50000 ppm, preferably 10 to 20000 ppm.

### (2) Film Forming

The aforementioned resins can be formed into a film by solution film forming or melt film forming, and in the case of saturated norbornene resin, melt film forming is preferred, while both are useful in the case of cellulose acylate resin. Solution film forming and melt film forming are described below.

### (Solution Film Forming)

As the solvent to be used in the solution film forming of cellulose acylate resin, the following (a) chlorinated solvent and (b) non-chlorinated solvent may be used.

### (a) Chlorinated Solvent

Preferred chlorinated organic solvents include dichloromethane and chloroform, and particularly preferred is dichloromethane. In addition, an organic solvent other than the chlorinated organic solvents may be mixed without problems. In that case, at least 50% by mass of dichloromethane should be used.

The non-chlorinated organic solvent used together in the present invention is described in the following. Specifically, as a non-chlorinated organic solvent, a solvent selected from esters, ketones, ethers, alcohols and hydrocarbons having 3 to 12 carbon atoms is preferable. Those esters, ketones, ethers and alcohols may have a cyclic structure. Compounds having at least two kinds of ester, ketone and ether functionalities (i.e., —O—, —CO— and —COO—) may be used as a solvent, and these compounds may also contain other functionalities such as alcoholic hydroxyl group. The number of carbon atoms of the solvent having two or more kinds of functionalities may be within the determined range of the number of carbon atoms of the compound having any of those functionalities. Examples of esters having 3 to 12 carbon atoms include ethyl formate, propyl formate, pentyl formate, methyl acetate, ethyl acetate and pentyl acetate. Examples of ketones having 3 to 12 carbon atoms include acetone, methyl ethyl ketone, diethyl ketone, diisobutyl ketone, cyclopentanone, cyclohexanone and methyl cyclohexanone. Examples of ethers having 3 to 12 carbon atoms include diisopropyl ether, dimethoxymethane, dimethoxyethane, 1,4-dioxane, 1,3-dioxolane, tetrahydrofuran, anisole and phenetole. Examples of organic solvents having at least two functionalities include 2-ethoxyethyl acetate, 2-methoxyethanol and 2-buthoxyethanol.

Alcohols to be used together with chlorinated organic solvent may be linear, branched or cyclic, and among them, saturated aliphatic hydrocarbons are preferred. The hydroxyl group of alcohol may be any of primary to tertiary. Examples of alcohols include methanol, ethanol, 1-propanol, 2-propanol, 1-butanol, 2-butanol, t-butanol, 1-pentanol, 2-methyl-2-butanol and cyclohexanol. Fluorine alcohols may also be used as alcohol. Examples thereof include 2-fluoroethanol, 2,2,2-trifluoroethanol and 2,2,3,3-tetrafluoro-1-propanol. Further, hydrocarbon may be linear, branched or cyclic. Both aromatic hydrocarbon and aliphatic hydrocarbon may be used. Aliphatic hydrocarbon may be saturated or unsaturated. Examples of hydrocarbons include cyclohexane, hexane, benzene, toluene and xylene.

The non-chlorinated organic solvent used together with chlorinated organic solvent is not particularly limited, but selected from methyl acetate, ethyl acetate, methyl formate, ethyl formate, acetone, dioxolane, dioxane, ketones or acetoacetic esters having 4 to 7 carbon atoms, alcohols or hydrocarbons having 1 to 10 carbon atoms. Preferred non-chlorinated organic solvents to be used together include methyl acetate, acetone, ) methyl formate, ethyl formate, methyl ethyl ketone, cyclopentanone, cyclohexanone, methyl acetoacetate, methanol, ethanol, 1-propanol, 2-propanol, 1-butanol, 2-butanol, cyclohexanol, cyclohexane and hexane.

Combinations of chlorinated organic solvents which are main solvents preferred in the present invention are as described below, but not limited thereto (the numbers in parentheses in the following mean part(s) by mass).
dichloromethane/methanol/ethanol/butanol (80/10/5/5)
dichloromethane/acetone/methanol/propanol (80/10/5/5)
dichloromethane/methanol/butanol/cyclohexane (80/10/5/5)
dichloromethane/methyl ethyl ketone/methanol/butanol (80/10/5/5)
dichloromethane/acetone/methyl ethyl ketone/ethanol/isopropanol (72/9/9/4/6)
dichloromethane/cyclopentanone/methanol/isopropanol (80/10/5/5)
dichloromethane/methyl acetate/butanol (80/10/10)
dichloromethane/cyclohexanone/methanol/hexane (70/20/5/5)
dichloromethane/methyl ethyl ketone/acetone/methanol/ethanol (50/20/20/5/5)
dichloromethane/1,3-dioxolane/methanol/ethanol (70/20/5/5)
dichloromethane/dioxane/acetone/methanol/ethanol (60/20/10/5/5)
dichloromethane/acetone/cyclopentanone/ethanol/isobutanol/cyclohexane (65/10/10/5/5/5)
dichloromethane/methyl ethyl ketone/acetone/methanol/ethanol (70/10/10/5/5)
dichloromethane/acetone/ethyl acetate/ethanol/butanol/hexane (65/10/10/5/5/5)
dichloromethane/methyl acetoacetate/methanol/ethanol (65/20/10/5)
dichloromethane/cyclopentanone/ethanol/butanol (65/20/10/5)

### (b) Non-Chlorinated Solvent

As a non-chlorinated organic solvent, a solvent selected from esters, ketones and ethers having 3 to 12 carbon atoms is preferable. Those esters, ketones and ethers may have a cyclic structure. Compounds having at least two kinds of ester, ketone and ether functionalities (i.e., —O—, —CO— and —COO—) may be used as the main solvent, and these compounds may also contain other functionalities such as alcoholic hydroxyl group. The number of carbon atoms of the main solvent having two or more kinds of functionalities may be within the determined range of the number of carbon atoms of the compound having any of those functionalities. Examples of esters having 3 to 12 carbon atoms include ethyl formate, propyl formate, pentyl formate, methyl acetate, ethyl acetate and pentyl acetate. Examples of ketones having 3 to 12 carbon atoms include acetone, methyl ethyl ketone, diethyl ketone, diisobutyl ketone, cyclopentanone, cyclohexanone and methyl cyclohexanone. Examples of ethers having 3 to 12 carbon atoms include diisopropyl ether, dimethoxymethane, dimethoxyethane, 1,4-dioxane, 1,3-dioxolane, tetrahydrofuran, anisole and phenetole. Examples of organic solvents having at least two functionalities include 2-ethoxyethyl acetate, 2-methoxyethanol and 2-buthoxyethanol.

Further, a solvent preferable for the cellulose acylate used in the present invention is a mixed solvent of three or more different solvents, in which the first solvent is at least one selected from methyl acetate, ethyl acetate, methyl formate, ethyl formate, acetone, dioxolane and dioxane, or a mixture thereof, the second solvent is selected from ketones and acetoacetic esters having 4 to 7 carbon atoms, and the third solvent is selected from alcohols and hydrocarbons having 1 to 10 carbon atoms, which is more preferably alcohol having 1 to 8 alcohol. When the first solvent is a mixture of two or more solvents, the second solvent may not be used. The first solvent is more preferably methyl acetate, acetone, methyl formate, ethyl formate or a mixture thereof, and the second solvent is preferably methyl ethyl ketone, cyclopentanone, cyclohexanone, methyl acetoacetate, or a mixture of these.

Alcohols to be used as the third solvent may be linear, branched or cyclic, and among them, saturated aliphatic hydrocarbons are preferred. The hydroxyl group of alcohol may be any of primary to tertiary. Examples of alcohols include methanol, ethanol, 1-propanol, 2-propanol, 1-butanol, 2-butanol, t-butanol, 1-pentanol, 2-methyl-2-butanol and cyclohexanol. Fluorine alcohols may also be used as alcohol. Examples thereof include 2-fluoroethanol, 2,2,2-trifluoroethanol and 2,2,3,3-tetrafluoro-1-propanol. Further, hydrocarbon may be linear, branched or cyclic. Both aromatic hydrocarbon and aliphatic hydrocarbon may be used. Aliphatic hydrocarbon may be saturated or unsaturated. Examples of hydrocarbons include cyclohexane, hexane, benzene, toluene and xylene. These alcohols and hydrocarbons as the third solvent may be used alone or in a mixture of two or more without any particular limitation. Specific compounds preferred as the third solvent include alcohols such as methanol, ethanol, 1-propanol, 2-propanol, 1-butanol, 2-butanol, cyclohexanol, ) cyclohexane and hexane. Particularly preferred are methanol, ethanol, 1-propanol, 2-propanol and 1-butanol.

The above-described mixed solvent of the three preferably contains 20 to 95% by mass of the first solvent, 2 to 60% by mass of the second solvent and 2 to 30% by mass of the third solvent, more preferably 30 to 90% by mass of the first solvent, 3 to 50% by mass of the second solvent, and 3 to 25% by mass of the third alcohol, particularly preferably 30 to 90% by mass of the first solvent, 3 to 30% by mass of the second solvent, and 3 to 15% by mass of alcohol as the third solvent. When the first solvent is a mixture and the second solvent is not used, the mixed solvent preferably contains 20 to 90% by mass of the first solvent, 5 to 30% by mass of the third solvent, more preferably 30 to 86% by mass of the first solvent and 7 to 25% by mass of the third solvent. The above-described non-chlorinated organic solvents to be used in the present invention are described in detail in “Kokai Gifo of Japan Institute of Invention & Innovation” (Kogi No. 2001-1745, published Mar. 15, 2001, Japan Institute of Invention & Innovation), pp. 12-16.

Preferred combinations of non-chlorinated organic solvents in the present invention are as described below, but not limited thereto (the numbers in parentheses mean part(s) by mass).
methyl acetate/acetone/methanol/ethanol/butanol (75/10/5/5/5)
methyl acetate/acetone/methanol/ethanol/propanol (75/10/5/5/5)
methyl acetate/acetone/methanol/butanol/cyclohexane (75/10/5/5/5)
methyl acetate/acetone/ethanol/butanol (81/8/7/4)
methyl acetate/acetone/ethanol/butanol (82/10/4/4)
methyl acetate/acetone/ethanol/butanol (80/10/4/6)
methyl acetate/methyl ethyl ketone/methanol/butanol (80/10/5/5)
methyl acetate/acetone/methyl ethyl ketone/ethanol/isopropanol (75/8/8/4/5)
methyl acetate/cyclopentanone/methanol/isopropanol (80/10/5/5)
methyl acetate/acetone/butanol (85/10/5)
methyl acetate/cyclopentanone/acetone/methanol/butanol (60/15/15/5/5)
methyl acetate/cyclohexanone/methanol/hexane (70/20/5/5) methyl acetate/methyl ethyl ketone/acetone/methanol/ethanol (50/20/20/5/5)
methyl acetate/1,3-dioxolane/methanol/ethanol (70/20/5/5)
methyl acetate/dioxane/acetone/methanol/ethanol (60/20/10/5/5)
methyl acetate/acetone/cyclopentanone/ethanol/isobutanol/cyclohexane (65/10/10/5/5/5)
methyl formate/methyl ethyl ketone/acetone/methanol/ethanol (50/20/20/5/5)
methyl formate/acetone/ethyl acetate/ethanol/butanol/hexane (65/10/10/5/5/5)
acetone/methyl acetoacetate/methanol/ethanol (65/20/10/5)
acetone/cyclopentanone/ethanol/butanol (65/20/10/5)
acetone/1,3-dioxolane/ethanol/butanol (65/20/10/5)
1,3-dioxolane/cyclohexanone/methyl ethyl ketone/methanol/butanol (55/20/10/5/5/5)

Further, as described below, part of the solvent is additionally added after dissolving, so as to dissolve cellulose acylate in multiple steps (the numbers in parentheses mean part(s) by mass).

A cellulose acylate solution is prepared using methyl acetate/acetone/ethanol/butanol (81/8/7/4), and after subjecting the solution to filtration and concentration, 2 parts by mass of butanol is additionally added thereto.
A cellulose acylate solution is prepared using methyl acetate/acetone/ethanol/butanol (81/10/4/2), and after subjecting the solution to filtration and concentration, 4 parts by mass of butanol is additionally added thereto.
A cellulose acylate solution is prepared using methyl acetate/acetone/ethanol (84/10/6), and after subjecting the solution to filtration and concentration, 5 parts by mass of butanol is additionally added thereto.

In the present invention, regardless of whether the solvent is chlorinated or non-chlorinated, cellulose acylate is dissolved in the solvent in an amount of preferably 10 to 40% by mass, more preferably 13 to 35% by mass, and particularly preferably 15 to 30% by mass. Before dissolving, swelling may be carried out at 0° C. to 50° C. for 0.1 hour to 100 hours. Additives may be added before, during or after the swelling step, or during or after dissolving under cooling which follows the swelling step.

In the present invention, cooling or heating may be employed for dissolving cellulose acylate. For cooling and heating, methods described in Japanese Patent Application Laid-Open Nos. 11-323017, 10-67860, 10-95854, 10-324774 and 11-302388 can be used. Specifically, a solvent and cellulose acylate are mixed and the resultant is ) swelled to dissolve the cellulose acylate using a screw kneader equipped with a cooling jacket.

The dope prepared in the present invention is preferably subjected to concentration and filtration, and the methods described in detail in “Kokai Gifo of Japan Institute of Invention & Innovation” (Kogi No. 2001-1745, published Mar. 15, 2001, Japan Institute of Invention & Innovation), p. 25 may be used.

### (Melt Film Forming)

### (a) Cellulose Acylate Film

### [Drying]

Although resins may be used in the form of powder, pelletized resin is more preferably used in order to reduce variation in the thickness of the formed film. After adjusting the moisture content of the resin to 1% or less, more preferably 0.5% or less, the resin is introduced into the hopper of a melt extruder. At this time, the hopper is set to not lower than Tg-50° C. and not higher than Tg+30° C., more preferably not lower than Tg−40° C. and not higher than Tg+10° C., further preferably not lower than Tg−30° C. and not higher than Tg. According to this, moisture readsorption in the hopper is prevented and efficiency of the aforementioned drying can be easily achieved.

### [Kneading and Extrusion]

Kneading is carried out to melt the resin at 120° C. to 250° C., more preferably 140° C. to 220° C., further preferably 150° C. to 200° C. At this stage, the melting temperature may be constant or controlled with dividing into some sections. The kneading time is preferably 2 minutes to 60 minutes, more preferably 3 minutes to 40 minutes, further preferably 4 minutes to 30 minutes. Further, kneading may be carried out in the melt extruder under inert current (nitrogen, etc.), or with evacuating using an extruder equipped with a vent.

### [Casting]

The molten resin is passed through a gear pump to remove the pulsation from the extruder, filtrated with a metal mesh filter, and extruded through a T-shaped die attached behind the filter on a cooling drum in the form of a sheet. The resin may be extruded in a single layer or in multiple layers using a multimanifold die or a feed block die. At this time, by adjusting the lip interval of the die, thickness irregularity in the width direction can be controlled.

The resin is then extruded on a casting drum. At this stage, using an electrostatic application method, an air knife method, an air chamber method, a vacuum nozzle method or a touch roll method, adhesion between the casting drum and the melt-extruded sheet may be increased. All or part of the melt-extruded sheet may be subjected to such adhesion improvement treatment.

The temperature of the casting drum is preferably 60° C. or higher and 160° C. or lower, more preferably 70° C. or higher and 150° C. or lower, further preferably 80° C. or higher and 150° C. or lower. The sheet is then peeled off from the casting drum and taken up past a nip roll. The take-up rate is preferably 10 m/minute to 100 m/minute, more preferably 15 m/minute to 80 m/minute, further preferably 20 m/minute to 70 m/minute.

The width of the formed film is 1 m to 5 m, more preferably 1.2 m to 4 m, further preferably 1.3 m to 3 m. The unstretched film thus obtained has a thickness of preferably 30 μm to 400 μm, more preferably 40 μm to 300 μm, further preferably 50 μm to 200 μm.

It is preferable that both ends of the sheet thus obtained are trimmed before taking up the sheet. Pieces produced after trimming are crushed or subjected to granulation, depolymerization or repolymerization according to need to be reused as a film material of the same kind or different kind. In addition, applying a laminate film on at least one surface before take up is preferred in view of preventing scars.

### (b) Saturated Norbornene Film

Pellets of saturated norbornene resin are placed in a melt extruder and after dehydrating at 100° C. or more to 200° C. or less for 1 minute or more to 10 hours or less, kneading and extrusion are conducted. For kneading, a single screw or twin screw extruder may be used.

Film forming may be carried out in the same manner as in the case of the aforementioned cellulose acylate film except that the melting temperature is set to 240 to 320° C., more preferably 250 to 310° C., further preferably 260 to 300° C., and the temperature of the casting drum is set to 80 to 170° C., more preferably 90° C. or more to 160° C. or less, further preferably 100° C. or more to 150° C. or less.

The thickness irregularity of the thermoplastic film formed by the ) aforementioned method is preferably not less than 0% and not more than 2%, more preferably not less than 0% and not more than 1.5%, further preferably not less than 0% and not more than 1% in both the length direction and the width direction, and the film is then stretched according to the method described above, whereby the thermoplastic film of the present invention is produced.

### (3) Processing of Thermoplastic Film

The thermoplastic film biaxially stretched according to the aforementioned method may be used alone or in combination with a polarizing plate, or a liquid crystal layer, a layer having controlled refractive index (low-reflection layer) or a hard coat layer may be formed thereon. These configurations can be achieved according to the following methods.

### (Surface Treatment)

By subjecting the thermoplastic film to a surface treatment, adhesion between the film and each functional layer (e.g., an undercoat layer and a back layer) can be improved. For example, a glow discharge treatment, ultraviolet irradiation, a corona treatment, a flame treatment and an acid or alkali treatment may be used. The glow discharge treatment in this case may be cold plasma occurring under a low gas pressure of 10⁻³ to 20 Torr, or plasma treatment under atmospheric pressure is also preferred. Plasma excitation gas means one which can be excited to be plasma under conditions as described above, and examples thereof include argon, helium, neon, krypton, xenon, nitrogen, carbon dioxide, chlorofluorocarbons such as tetrafluoromethane and a mixture thereof. These details are described in “Kokai Gifo of Japan Institute of Invention & Innovation” (Kogi No. 2001-1745, published Mar. 15, 2001, Japan Institute of Invention & Innovation), pp. 30-32. In the plasma treatment under atmospheric pressure which is now attracting attention, a radiating energy of 20 to 500 Kgy is used under a condition of 10 to 1000 Kev, and more preferably a radiating energy of 20 to 300 Kgy is used under a condition of 30 to 500 Kev.

Of these treatments, an alkali saponifying treatment is particularly preferable for cellulose acylate films and a glow discharge treatment, a corona treatment and a flame treatment are preferable for saturated norbornene films.

In an alkali saponifying treatment, the film may be immersed into a saponifying solution (immersing method), or may be coated with the saponifying solution (coating method). The immersing method can be accomplished by passing the film through a tank containing an aqueous NaOH or KOH solution of a pH of 10 to 14 heated to 20 to 80° C. for 0.1 to 10 minutes, followed by neutralization, water washing and drying.

For the coating method, dip coating, curtain coating, extrusion coating, bar coating and type E coating may be used. As the solvent for the alkali saponifying treatment coating solution, a solvent having excellent wettability appropriate for applying the saponifying solution to a transparent support and capable of maintaining good surface conditions without forming any irregularity on the surface of the transparent support is preferably selected. Specifically, alcohol solvents are preferred, and isopropyl alcohol is particularly preferred. In addition, an aqueous surfactant solution may be used as a solvent. As alkali for the alkali saponifying coating solution, those soluble in the aforementioned solvent is preferred, and KOH and NaOH are more preferred. The pH of the saponifying coating solution is preferably not less than 10, more preferably not less than 12. As for the reaction conditions of the alkali saponification, the reaction may be carried out at room temperature for preferably not less than 1 second and not more than 5 minutes, more preferably not less than 5 seconds and not more than 5 minutes, particularly preferably not less than 20 seconds and not more than 3 minutes. After the alkali saponification reaction, the surface coated with the saponifying solution may be washed with water, or with acid and then with water. The coating saponifying treatment and application of alignment film described later may be continuously carried out, whereby the number of the steps can be reduced. These saponifying methods are specifically described in, for example, Japanese Patent Application Laid-Open No. 2002-82226 and WO 02/46809.

It is also preferable to form an undercoat layer for adhering to the functional layer. Such layer may be formed by coating after the aforementioned surface treatment or without any surface treatment. Details of undercoat layer are described in “Kokai Gifo of Japan Institute of Invention & Innovation” (Kogi No. 2001-1745, published Mar. 15, 2001, Japan Institute of Invention & Innovation), p. 32.

The surface treatment step and the undercoat step may be included in the last stage of the film forming processes, may be independently carried out, or may be carried out in the process of applying functional layers described below.

### (Application of Functional Layer)

The thermoplastic film of the present invention may be used together with functional layers described in “Kokai Gifo of Japan Institute of Invention & Innovation” (Kogi No. 2001-1745, published Mar. 15, 2001, Japan Institute of Invention & Innovation), pp. 32 to 45. Particularly preferred is to apply a polarizing layer (polarizing plate), a compensation layer (compensation sheet), or an anti-reflection layer (anti-reflection film).

### (A) Application of Polarizing Layer (Preparation of Polarizing Plate)

### (A-1) Used Materials

Commercially available polarizing layers are now generally prepared by immersing stretched polymer into an iodine or dichroic dye solution in a bath, thereby impregnating the iodine or dichroic dye into the binder. As the polarizing film, coating-type polarizing films typically available from Optiva Inc. can also be used. In a polarizing film, iodine or dichroic dye is oriented in the binder to exhibit polarizing characteristics. As dichroic dye, an azo dye, a stilbene dye, a pyrazolone dye, a triphenylmethane dye, a quinoline dye, an oxazine dye, a thiazine dye or an anthraquinone dye may be used. And water-soluble dichroic dyes are preferred. Such dichroic dye preferably contains a hydrophilic substituent (e.g., sulfo, amino or hydroxyl group). Examples thereof include compounds described in “Kokai Gifo of Japan Institute of Invention & Innovation” (Kogi No. 2001-1745, published on Mar. 15, 2001), p. 58.

As a binder for polarizing film, polymers capable of cross-linking by themselves, polymers cross-linked in the presence of a cross-linking agent, or combinations thereof may be used. Examples of binders include methacrylate copolymers, styrene copolymers, polyolefin, polyvinyl alcohol, modified polyvinyl alcohol, poly(N-methylolacrylamide), polyester, polyimide, vinyl acetate copolymers, carboxymethyl cellulose and polycarbonate described in paragraph [0022] of the specification of Japanese Patent Application Laid-Open No. 8-338913. A silane coupling agent can be used as such polymer. Of these, water-soluble polymers (e.g., poly(N-methylolacrylamide), carboxymethyl cellulose, gelatin, polyvinyl alcohol and modified polyvinyl alcohol) are preferred, gelatin, polyvinyl alcohol and modified polyvinyl alcohol are more preferred, and polyvinyl alcohol and modified polyvinyl alcohol are most preferred. It is particularly preferable to use two kinds of polyvinyl alcohols or modified polyvinyl alcohols of different polymerization degrees. Such polyvinyl alcohol preferably has a saponification degree of preferably 70 to 100%, more preferably 80 to 100%. The polymerization degree of polyvinyl alcohol is preferably 100 to 5,000. Examples of modified polyvinyl alcohol are described in Japanese Patent Application Laid-Open Nos. 8-338913, 9-152509 and 9-316127. Two or more kinds of polyvinyl alcohols or modified polyvinyl alcohols may be used together.

The lower limit of the thickness of the binder is preferably 10 μm. Regarding the upper limit of the thickness, the binder is preferably as thin as possible from the viewpoint of light leakage from the liquid crystal display device. The binder is preferably thinner than the thickness of a polarizing plate currently commercially available (about 30 μm), more preferably 25 μm or less, further preferably 20 μm or less.

The binder in the polarizing film may be cross-linked. A polymer or monomer having a cross-linkable functional group may be mixed with the binder, or a cross-linkable functional group may be directly added to the binder polymer. The binder may be cross-linked by means of light, heat, or pH change, and a binder having a cross-linked structure can be then formed. Cross-linking agents are described in U.S. Pat. Re-issue No. 23297. In addition, boron compounds (e.g., boric acid and borax) may be used as a cross-linking agent. The amount of the cross-linking agent added to the binder is preferably 0.1 to 20% by mass based on the amount of the binder. In this range, the orientation of the polarizer and the wet heat resistance of the polarizing film are improved.

After completion of the cross-linking reaction, the amount of non-reacted cross-linking agent is preferably not more than 1.0% by mass, more preferably not more than 0.5% by mass. This makes it possible to improve weather resistance.

### (A-2) Stretching of Polarizing Layer

A polarizing film is preferably stretched (stretching method) or rubbed (rubbing method), and then dyed with iodine or dichroic dye.

In the stretching method, the stretching ratio of the film is preferably 2.5 to 30.0 times, more preferably 3.0 to 10.0 times. Stretching can be carried out by dry stretching under air or wet stretching with immersing the film in water. The stretching ratio in dry ) stretching is preferably 2.5 to 5.0 times, and the stretching ratio in the wet stretching is preferably 3.0 to 10.0 times. The film may be stretched in parallel (parallel stretching) or obliquely (oblique stretching) to the MD direction. Stretching may be carried out at one time or several times. By stretching several times, the film can be uniformly stretched even when stretched at high stretching ratios.

### a) Parallel Stretching

Before stretching, PVA film is swelled. The swelling degree thereof (the ratio based on the weight of the film before and after swelling) is from 1.2 to 2.0 times. The film is then continuously transferred by guide rolls and stretched in an aqueous medium bath or a dyeing bath containing dissolved dichroic material at a bath temperature of preferably 15° C. to 50° C., more preferably 17° C. to 40° C. Stretching can be carried out by holding the film by two pairs of nip rolls with setting the transferring rate of the rearward nip rolls larger than that of the forward nip rolls. The stretching ratio, which is the ratio of the length after stretching/at the initial stage (hereinafter the same), is preferably 1.2 to 3.5 times, more preferably 1.5 to 3.0 times from the viewpoint of the above-mentioned effects and advantages. The film is then dried at 50° C. to 90° C. to give a polarizing film.

### b) Oblique Stretching

For this stretching, a method of stretching using a tenter projected in an oblique direction described in Japanese Patent Application Laid-Open No. 2002-86554 can be used. Because this stretching is performed under air, the film must be previously hydrated so as to facilitate the stretching. The moisture content is preferably not less than 5% and not more than 100%, more preferably not less than 10% and not more than 100%.

The temperature at the time of stretching is preferably not lower than 40° C. and not higher than 90° C., more preferably not lower than 50° C. and not higher than 80° C. The humidity is preferably not lower than 50% rh and not higher than 100% rh, more preferably not lower than 70% rh and not higher than 100% rh, further preferably not lower than 80% rh and not higher than 100% rh. The traveling rate in the longitudinal direction is preferably not less than 1 m/minute, more preferably not less than 3 m/minute.

After completion of the stretching, drying is carried out at preferably not lower than 50° C. and not higher than 100° C., more preferably not lower than 60° C. and not higher than 90° C., for preferably not less than 0.5 minute and not more than 10 minutes, more preferably not less than 1 minute and not more than 5 minutes.

The angle of the absorption axis of the thus-obtained polarizing film is preferably 10 to 80 degrees, more preferably 30 to 60 degrees, further preferably substantially 45 degrees (40 to 50 degrees).

### (A-3) Adhesion

The saponified cellulose acylate film and the polarizing layer prepared by stretching are adhered to prepare a polarizing plate. Regarding the direction of adhesion, they are preferably adhered so that the direction of the flow casting axis of the cellulose acylate film and the stretching axis of the polarizing plate form an angle of 45 degrees.

The adhesive for the adhesion is not particularly limited, and examples thereof include PVA resins (including PVA modified by an acetoacetyl, sulfonic acid, carboxyl or oxyalkylene group) and aqueous solutions of a boron compound. Of these, PVA resins are particularly preferable. The adhesive layer has a thickness of preferably 0.01 to 10 μm, particularly preferably from 0.05 to 5 μm after drying.

The thus-obtained polarizing plate preferably has a higher light transmittance and a higher polarization degree. The light transmittance of the polarizing plate against light having a wavelength of 550 nm is in the range of preferably from 30 to 50%, more preferably from 35 to 50%, most preferably from 40 to 50%. The polarization degree thereof relative to light having a wavelength of 550 nm is in the range of preferably from 90 to 100%, more preferably from 95 to 100%, most preferably from 99 to 100%.

The thus-obtained polarizing plate is stacked with a λ/4 plate to produce circularly polarized light. In this case, they are stacked so that the angle between the retarded phase axis of the λ/4 plate and the absorption axis of the polarizing plate is 45 degrees. The λ4 plate used here is not particularly limited, but is preferably those having a wavelength dependency such that the lower the wavelength, the smaller the retardation. In addition, a λ/4 plate composed of a polarizing film in which the absorption axis is tilted 20 to 70 degrees in the longitudinal direction and an optically anisotropic layer made of a liquid crystal compound is preferably used.

### (B) Application of Compensation Layer (Production of Compensation Sheet)

A compensation layer compensates for a liquid crystal compound in a liquid crystal cell when a liquid crystal display device displays black, and is prepared by forming an alignment film on a cellulose acylate film and applying an optically anisotropic layer thereon.

### (B-1) Alignment Film

An alignment film is formed on the aforementioned surface-treated cellulose acylate film. The alignment film has a function of defining the orientation direction of liquid crystal molecules. However, once a liquid crystal compound is oriented and the orientation state is subsequently fixed, the alignment film is no longer an essential constituent of the present invention because the function has been fulfilled. In other words, the polarizing plate of the present invention can also be produced by transferring, to a polarizer, only an optically anisotropic layer with fixed orientation state which is formed on an alignment film.

An alignment film can be formed by means such as rubbing treatment of an organic compound (preferably a polymer), oblique evaporation of an inorganic compound, or formation of a layer with microgrooves or accumulation of an organic compound (e.g., ω-tricosanic acid, dioctadecylmethylammonium chloride and methyl stearate) according to the Langmuir-Blodgett method (LB film). In addition, alignment films which attain orientation function by applying an electric field, applying a magnetic field, or by irradiating with light are known.

The alignment film is preferably formed by subjecting a polymer to a rubbing treatment. In principle, the polymer used for an alignment film has a molecular structure capable of orientating liquid crystal molecules.

In the present invention, in addition to the function of orientating liquid crystal molecules, a side chain having a cross-linkable functional group (e.g., a double bond) may be bonded to the main chain, or a cross-linkable functional group capable of orientating liquid crystal molecules may be introduced into the side chain.

Polymers to be used for the alignment film may be polymers capable of cross-linking by themselves, polymers to be cross-linked in the presence of a cross-linking agent, or combinations thereof. Examples of such polymers include methacrylate copolymers, styrene copolymers, polyolefin, polyvinyl alcohol, modified polyvinyl alcohol, poly(N-methylolacrylamide), polyester, polyimide, vinyl acetate copolymers, carboxymethyl cellulose and polycarbonate which are described in paragraph [0022] of the specification of Japanese Patent Application Laid-Open No. 8-338913. A silane coupling agent can be used as such polymer. Of these, water-soluble polymers (e.g., poly(N-methylolacrylamide), carboxymethyl cellulose, gelatin, polyvinyl alcohol and modified polyvinyl alcohol) are preferred, gelatin, polyvinyl alcohol and modified polyvinyl alcohol are more preferred, and polyvinyl alcohol and modified polyvinyl alcohol are most preferred. It is particularly preferable to use two kinds of polyvinyl alcohols or modified polyvinyl alcohols of different polymerization degrees. Such polyvinyl alcohol preferably has a saponification degree of preferably 70 to 100%, more preferably 80 to 100%. The polymerization degree of the polyvinyl alcohol is preferably 100 to 5,000.

The side chain having a function of orientating liquid crystal molecules generally has a hydrophobic group as a functional group. Specific kinds of such functional groups are determined based on the kind and the required orientation state of the liquid crystal molecules. Modifying groups of modified polyvinyl alcohol can be introduced by copolymerization, chain transfer or block polymerization. Examples of modifying groups include hydrophilic groups (carboxylic group, sulfonic group, phosphonic group, amino group, ammonium group, amido group, thiol group), hydrocarbon groups having 10 to 100 carbon atoms, fluorine-substituted hydrocarbon groups, thioether groups, polymerizable groups (unsaturated polymerizable group, epoxy group, aziridinyl group), and alkoxysilyl groups (trialkoxysilyl, dialkoxysilyl, monoalkoxysilyl). Specific examples of such modified polyvinyl alcohols are described in Japanese Patent Application Laid-Open No. 2000-155216, paragraphs [0022] to [0145], and Japanese Patent Application Laid-Open No. 2002-62426, paragraphs [0018] to [0022].

By allowing a side chain having a cross-linkable functional group to be bonded to the main chain of the alignment film polymer or introducing, into a side chain, a crosslinkable functional group having a function of orientating liquid crystal molecules, the alignment film polymer can be copolymerized with polyfunctional monomers contained in the optically anisotropic layer. As a result, not only the polyfunctional monomers themselves, but also the alignment film polymers themselves, and in addition, the polyfunctional monomer and the alignment film polymer, are strongly bonded via a covalent bond. Thus, by introducing a crosslinkable functional group into the alignment film polymer, the strength of the compensation sheet can be significantly improved.

The crosslinkable functional group of the alignment film polymer preferably contains a polymerizable group as the polyfunctional monomer does. Specific examples thereof are described in Japanese Patent Application Laid-Open No. 2000-155216, paragraphs [0080] to [0100]. The alignment film polymer may be cross-linked using a cross-linking agent, not only by the aforementioned cross-linkable functional group.

Examples of such cross-linking agent include aldehyde, N-methylol compounds, dioxane derivatives, compounds that function when the carboxylic group is activated, active vinyl compounds, active halogen compounds, isooxazole and dialdehyde starch. Two or more crosslinking agents may be used in combination. Specific examples thereof include compounds described in Japanese Patent Application Laid-Open No. 2002-62426, paragraphs [0023] to [0024]. Highly reactive aldehyde, especially glutaraldehyde, is preferred.

The amount to be added of the cross-linking agent is preferably 0.1 to 20% by mass, more preferably 0.5 to 15% by mass based on the amount of the polymer. The amount of non-reacted crosslinking agent remaining in the alignment film is preferably not more than 1.0% by mass, more preferably not more than 0.5% by mass. By adjusting the amount in this way, sufficient durability can be obtained without causing reticulation even if the alignment film is used in a liquid crystal display device for a long time or left in a high-temperature and high-humidity atmosphere for a long time.

The alignment film can be basically formed by applying a solution containing the aforementioned polymer which is a material for forming the alignment film and a cross-linking agent on a transparent substrate, drying by heating (to be cross-linked) and subjecting to a rubbing treatment. As described above, the cross-linking reaction can be carried out at any stage after applying the solution on the transparent substrate. When a water-soluble polymer such as polyvinyl alcohol is used as a material for forming the alignment film, the coating solution is preferably a mixture of an organic solvent having a defoaming action (e.g., methanol) and water. The ratio of water to methanol is preferably from 0:100 to 99:1, more preferably from 0:100 to 91:9, by mass. This prevents foams from being generated and defects in the alignment film, also on the surface of the optically anisotropic layer, can be significantly decreased.

As a method of coating the alignment film, spin coating, dip coating, curtain coating, extrusion coating, rod coating and roll coating are preferable, and of these, rod coating is particularly preferable. The film thickness after drying is preferably 0.1 to 10 μm. The drying by heating may be conducted at a temperature of 20° C. to 110° C. To achieve sufficient cross-linking, the drying temperature is preferably from 60° C. to 100° C., particularly preferably from 80° C. to 100° C. The drying time is generally from 1 minute to 36 hours, preferably from 1 to 30 minutes. Further, the pH may be adjusted to an optimal value for the cross-linking agent to be used, and when glutaraldehyde is used as a cross-linking agent, the pH is preferably 4.5 to 5.5, particularly preferably 5.

The alignment film is provided on the transparent support or the undercoat layer described above. The alignment film can be obtained by crosslinking the aforementioned polymer layer and then subjecting the surface of the layer to a rubbing treatment.

For the rubbing treatment, methods widely used for orientating liquid crystals of LCD can be applied. More specifically, a method in which the surface of an orientation film is rubbed in a fixed direction using paper, gauze, felt, rubber, nylon or polyester fiber to obtain orientation can be employed. In general, this is carried out by rubbing the film surface several times with a cloth to which fibers of the same length and diameter are uniformly transplanted.

When practicing the rubbing treatment on an industrial scale, the treatment is carried out by contacting a rotating rubbing roll with a film to which a polarizing layer is adhered, with transporting the film. The circularity, cylindricality and deflection (decentration) of the rubbing roll are all preferably 30 μm or less. The wrap angle of the film relative to the rubbing roll is preferably 0.1 to 90°. However, as described in Japanese Patent Application Laid-Open No. 8-160430, stable rubbing can be also achieved by winding the film around the roll with a wrap angle of 360° (one turn) or more; The traveling speed of the film is preferably 1 to 100 m/minute. Regarding the rubbing angle, an appropriate rubbing angle is selected from the range of 0 to 60°. When the film is used in a liquid crystal display, the rubbing angle is preferably 40 to 50°, particularly preferably 45°.

The alignment film thus obtained has a film thickness of preferably 0.1 to 10 μm.

Liquid crystal molecules in the optically anisotropic layer are then orientated on the alignment film. Subsequently, the alignment film polymer and the multifunctional monomer contained in the optically anisotropic layer are allowed to react or the alignment film polymer is cross-linked using a cross-linking agent according to need.

The liquid crystal molecules used for the optically anisotropic layer include bar-like liquid crystal molecules and disk-like liquid crystal molecules. The bar-like liquid crystal molecule and the disk-like liquid crystal molecule may be a high molecular weight liquid crystal or a low molecular weight liquid crystal, and those in which a low molecular weight liquid crystal has been cross-linked and no liquid crystallinity is thus exhibited may also be included.

### (B-2) Bar-Like Liquid Crystal Molecule

As the bar-like liquid crystal molecule, azomethines, azoxy compounds, cyanobiphenyls, cyanophenyl esters, benzoic acid esters, cyclohexanecarboxylic acid phenyl esters, cyanophenyl cyclohexanes, cyano-substituted phenylpyrimidines, alkoxy-substituted phenylpyrimidines, phenyldioxanes, tolan compounds and alkenylcyclohexyl benzonitriles are preferably used.

The bar-like liquid crystal molecule may be a metal complex. Liquid crystal polymers containing bar-like liquid crystal molecules in the repeat units can also be used as the bar-like liquid crystal molecule. In other words, the bar-like liquid crystal molecule may be bonded to a (liquid crystal) polymer.

Bar-like liquid crystal molecules are described in Chapters 4, 7, and 11 in “Chemistry of Liquid Crystal”, Survey of Chemistry, Quarterly, Vol. 22, edited by the Chemical Society of Japan (1994), and Chapter 3 in “Liquid Crystal Device Handbook” edited by the 142 Committee of the Japan Society for the Promotion of Science.

The birefringent index of the bar-like liquid crystal molecules is preferably in the range of 0.001 to 0.7. It is preferable that the bar-like liquid crystal molecule contains a polymerizable group so that the orientation state can be fixed. The polymerizable group is preferably a radically polymerizable unsaturated group or a cationically polymerizable group. Specific examples thereof include polymerizable groups and polymerizable liquid crystal compounds described in Japanese Patent Application Laid-Open No. 2002-62427, paragraphs [0064] to [0086].

### (B-3) Disk-Like Liquid Crystal Molecule

Examples of disk-like (discotic) liquid crystal molecule include benzene derivatives described in a study report of C. Destrade et al., Mol. Cryst., vol. 71, p. 111 (1981); truxene derivatives described in a study report of C. Destrade et al., Mol. Cryst., vol. 122, p. 141 (1985) and Phyicslett., A, vol. 78, p. 82 (1990); cyclohexane derivatives described in a study report of B. Kohne et al., Angew. Chem. Soc., vol. 96, p. 70 (1984); and azacrown or phenylacetylene macrocycles described in a study report of J. M. Lehn et al., J. Chem. Commun. p. 1794 (1985) and a study report of J. Zhang et al., J. Am. Chem. Soc. vol. 116, p. 2655 (1994).

As the disk-like liquid crystal molecule, liquid crystal compounds in which a linear alkyl group, alkoxy group or a substituted benzoyloxy group constitutes a side chain, being present as a substituent radially to the parent core located at the center of the molecule are also included. Compounds in which a molecule or a cluster of molecules has rotational symmetry and which can thus give a certain orientation are preferred. Regarding the optically anisotropic layer formed from the disk-like liquid crystal molecule, the compound finally contained in the optically anisotropic layer need not be a disk-like liquid crystal molecule, and for example, a compound in which a low molecular weight disk-like liquid crystal molecule containing a group reactive to heat or light is consequently polymerized or cross-linked and thus the molecular weight is increased and the liquid crystallinity is lost may also be included. Preferred examples of disk-like liquid crystal molecules are described in Japanese Patent Application Laid-Open No. 8-50206. Polymerization of disk-like liquid crystal molecule is described in Japanese Patent Application Laid-Open No. 8-27284 describes.

To fix the disk-like liquid crystal molecule by polymerization, it is necessary to bond a polymerizable group as a substituent to the disk-like core of the disk-like liquid crystal molecule. A compound in which the disk-like core and the polymerizable group are bonded through a linking group is preferred, and this makes it possible to maintain the orientation state even in the polymerization reaction. Examples of such compound include compounds described in Japanese Patent Application Laid-Open No. 2000-155216, paragraphs [0151] to [0168].

In hybrid orientation, the angle between the major axis (disc plane) of disk-like liquid crystal molecule and the plane of the polarizing film is increased or decreased with respect to increase in the distance from the plane of the polarizing film in the direction of the depth of the optically anisotropic layer. The angle is preferably decreased as the distance is increased. Further, possible variations of angles include continuous increase, continuous decrease, intermittent increase, intermittent decrease, variation including continuous increase and continuous decrease, and intermittent variation including increase and decrease. In the intermittent variation, there is a region in which the tilt angle does not vary in the thickness direction. Regarding this angle, there may be regions in which the angle does not vary, as long as the angle is totally increased or decreased. Further, the angle is preferably totally continuously increased.

The average direction of the major axes of the disk-like liquid crystal molecules on the polarizing film side can be generally adjusted by selecting the kind of disk-like liquid crystal molecule or the material of the alignment layer, or by selecting the method of rubbing. The direction of the major axis (disc plane) of the disk-like liquid crystal molecule on the surface side (air side) can be generally adjusted by selecting the kind of disk-like liquid crystal molecule or additives used together with the disk-like liquid crystal molecule. Examples of additives used together with the disk-like liquid crystal molecule include plasticizers, surfactants, polymerizable monomers and polymers. Further, the degree of variation in the orientated direction of the major axes can be controlled by selecting the kind of disk-like liquid crystal molecule and additives as described above.

### (B-4) Other Components in Optically Anisotropic Layer

A plasticizer, a surfactant or a polymerizable monomer may be used together with the aforementioned liquid crystal molecules to improve the uniformity of the coating film, the strength of the film and the orientation property of the liquid crystal molecules. It is preferable that these components are compatible with the liquid crystal molecules so that they can change the tilt angle of the liquid crystal molecules, or do not hinder the orientation.

The polymerizable monomer may be a radically polymerizable or cationically polymerizable compound, and is preferably a radically polymerizable polyfunctional monomer, which is copolymerizable with the aforementioned liquid crystal compound containing a polymerizable group. Examples thereof include those described in Japanese Patent Application Laid-Open No. 2002-296423, paragraphs [0018] to [0020]. The amount to be added of the compound is generally in the range of 1 to 50%, preferably in the range of 5 to 30% by mass based on the amount of the disk-like liquid crystal molecule.

The surfactant may be a conventional known compound, but fluorine-containing compounds are particularly preferable. Specific examples thereof include compounds described in Japanese Patent Application Laid-Open No. 2001-330725, paragraphs to [0056].

It is preferable that the polymer used together with the disk-like liquid crystal molecule can change the tilt angle of the disk-like liquid crystal molecules.

An example of such polymer is cellulose ester. Preferable examples of cellulose ester are described in Japanese Patent Application Laid-Open No. 2000-155216, paragraph [0178]. To avoid hindering the orientation of the liquid crystal molecules, the amount to be added of the polymer is preferably in the range of 0.1 to 10% by mass, more preferably in the range of 0.1 to 8% by mass based on the amount of the liquid crystal molecule.

The transition temperature from the discotic nematic liquid crystal phase to the solid phase is preferably 70 to 300° C., more preferably 70 to 170° C.

### (B-5) Formation of Optically Anisotropic Layer

The optically anisotropic layer can be formed by applying a coating solution containing liquid crystal molecules and if necessary, a polymerization initiator or optional components described below onto the alignment film.

As the solvent used for preparing the coating solution, an organic solvent is preferably used. Examples of such organic solvent include amides (e.g., N,N-dimethylformamide), sulfoxides (e.g., dimethyl sulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone) and ethers (e.g., tetrahydrofuran, 1,2-dimethoxyethane). Of these, alkyl halides and ketones are preferred. Two or more organic solvents may be used together.

The coating solution can be applied by a known method (e.g., wire bar coating, extrusion coating, direct gravure coating, reverse gravure coating and die coating).

The optically anisotropic layer has a thickness of preferably 0.1 to 20 μm, more preferably 0.5 to 15 μm, and most preferably from 1 to 10 μm.

### (B-6) Fixing of Orientation State of Liquid Crystal Molecule

The oriented liquid crystal molecule can be fixed with maintaining the orientation state. The fixation is preferably carried out by a polymerization reaction. Such polymerization reactions include a thermal polymerization reaction using a thermal polymerization initiator and a photopolymerization reaction using a photopolymerization initiator, and a photopolymerization reaction is preferred.

Examples of photopolymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of a triarylimidazole dimer with p-aminophenyl ketone (described in U.S. Pat. No. 3,549,367), acridine or phenazine compounds (described in Japanese Patent Application Laid-Open No. 60-105667 and U.S. Pat. No. 4,239,850) and oxadiazole compounds (described in U.S. Pat. No. 4,212,970).

The amount to be used of the photopolymerization initiator is in the range of preferably 0.01 to 20% by mass, more preferably 0.5 to 5% by mass based on the solid component in the coating solution.

Regarding photoirradiation for polymerizing liquid crystal molecules, ultraviolet light is preferably used.

The radiating energy is in the range of preferably 20 mJ/cm² to 50 J/cm², more preferably 20 to 5000 mJ/cm², further preferably 100 to 800 mJ/cm². To facilitate the photopolymerization reaction, photoirradiation may be carried out under heating. A protective layer may be formed on the optically anisotropic layer.

It is also preferable to combine this compensation film with a polarizing layer. Specifically, a coating solution for an optically anisotropic layer as described above is applied to the surface of a polarizing film to form an optically anisotropic layer. Accordingly, a thin polarizing plate in which the stress (strain×cross-sectional area×elastic modulus) due to the dimensional change of the polarizing film is small can be produced without using any polymer film between the polarizing film and the optically anisotropic layer. When the polarizing plate of the present invention is incorporated into a large-sized liquid crystal display device, images having a high display quality can be displayed without causing problems such as light leakage.

As for the tilt angle between the polarizing layer and the compensation layer, stretching is preferably carried out so that the tilt angle is matched with the angle between the transmission axis of two polarizing plates adhered to both surfaces of a liquid crystal cell constituting a LCD and the longitudinal or transverse direction of the liquid crystal cell. The tilt angle is generally 45°, but recently, transmissive, reflective and semi-transmissive LCDs in which the tilt angle is not always 45° have been developed, and it is therefore preferable that the stretching direction can be randomly adjusted so as to conform to the design of LCDs.

### (B-7) Liquid Crystal Display Device

Liquid crystal modes in which such compensation film is used will be described.

### (TN Mode Liquid Crystal Display Device)

This is most widely used in color TFT liquid crystal display devices and described in many publications. Regarding the orientation state in the liquid crystal cell in the TN mode displaying black, bar-like liquid crystal molecules are vertically aligned at the central portions of the cell while the molecules are horizontally aligned in the vicinity of the cell substrates.

### (OCB Mode Liquid Crystal Display Device)

In this mode, the liquid crystal cell is in a bend orientation mode in which bar-like liquid crystal molecules in the upper part and in the lower part are substantially reversely (symmetrically) oriented. Liquid crystal display devices using such bend orientation mode liquid crystal cell are disclosed in U.S. Pat. Nos. 4,583,825 and 5,410,422. Since the bar-like liquid crystal molecules in the upper part and in the lower part are symmetrically oriented, the bend orientation mode liquid crystal cell has self-optical compensatory function. This mode is thus referred to as OCB (optically compensatory bend) mode.

Regarding the orientation state of the OCB mode liquid crystal cell displaying black, bar-like liquid crystal molecules are vertically aligned at the central portions of the cell while the molecules are horizontally aligned in the vicinity of the cell substrates as in the TN mode.

### (VA Mode Liquid Crystal Display Device)

This mode is characterized by bar-like liquid crystal molecules being substantially vertically aligned when no voltage is applied. The VA mode liquid crystal cells include (1) VA mode liquid crystal cells in a narrow sense in which bar-like liquid crystal molecules are substantially vertically aligned when no voltage is applied while they are substantially horizontally aligned when voltage is applied (described in Japanese Patent Application Laid-Open No. 2-176625); (2) liquid crystal cells in a mode (MVA mode) in which VA mode is converted to a multi-domain mode for enlarging the viewing angle (described in SID97, Digest of tech. Papers, 28 (1997), 845); (3) liquid crystal cells in a mode (n-ASM mode) in which bar-like liquid crystal molecules are substantially vertically aligned when no voltage is applied while they are aligned being twisted in multi-domains when voltage is applied (described in Preprints of Symposium on Japanese Liquid Crystal Society, (1998), 58-59); and (4) liquid crystal cells in SURVIVAL mode (published in LCD international 98).

### (Other Liquid Crystal Display Devices)

For liquid crystal display devices in ECB and STN modes, optical compensation can be achieved based on the same approach as described above.

### (C) Application of Anti-Reflection Layer (Anti-Reflection Film)

An anti-reflection film is generally prepared by forming, on a transparent substrate, a low refractive index layer which also serves as an antifouling layer and at least one layer in which the refractive index is higher than that of the low refractive index layer (i.e., high refractive index layer or middle refractive index layer).

Methods of forming a multi-layered film in which transparent thin films of inorganic compounds (metal oxides, etc.) of different refractive indexes are stacked include a chemical vapor deposition (CVD) method, a physical vapor deposition (PVD) method, and a method in which a metal compound such as metal alkoxide is subjected to a sol-gel method to be formed into a film of colloidal metal oxide particles, followed by post-treatment (ultraviolet radiation described in Japanese Patent Application Laid-Open No. 9-157855, or plasma treatment described in Japanese Patent Application Laid-Open No. 2002-327310) to form a thin film.

As high-productivity anti-reflection films, various anti-reflection films obtained by laminating by coating thin films of inorganic particles dispersed in a matrix are proposed.

An anti-reflection film composed of an anti-reflection layer to which an anti-glare property is imparted by forming fine irregularities on the uppermost layer of an anti-reflection film as described above which is formed by coating may also be used.

Although any of the aforementioned methods can be applied to the cellulose acylate film of the present invention, the coating method (coating type) is particularly preferred.

### (C-1) Layer Structure of Coating Type Antireflection Film

An anti-reflection film having a layer structure in which at least a middle refractive index layer, a high refractive index layer and a low refractive index layer (the outermost layer) are formed on a substrate in that order is to be designed to have refractive indexes satisfying the following relationship.

refractive index of high refractive index layer>refractive index of middle refractive index layer>refractive index of transparent substrate>refractive index of low refractive index layer.

A hard coat layer may be formed between the transparent substrate and the middle refractive index layer. The anti-reflection film may be composed of a middle refractive index hard coat layer, a high refractive index layer and a low refractive index layer.

Examples of such layer structure are described in Japanese Patent Application Laid-Open Nos. 8-122504, 8-110401, 10-300902, 2002-243906 and 2000-111706. In addition, those layers may be made to have different function, and examples of such layers include a low refractive index layer having an antifouling property and a high refractive index layer having an antistatic property (e.g., Japanese Patent Application Laid-Open Nos. 10-206603, 2002-243906).

The anti-reflection film has a haze of preferably not more than 5%, more preferably not more than 3%. The strength of the film is preferably H or higher, more preferably 2H or higher, and most preferably 3H or higher as measured by the pencil hardness test in accordance with JIS K5400.

### (C-2) High Refractive Index Layer and Middle Refractive Index Layer

The high refractive index layer of the anti-reflection film is a curable film containing at least inorganic compound ultrafine particles having a high refractive index and an average particle size of 100 nm or less, and a matrix binder. The inorganic compound ultrafine particles of high refractive index may be an inorganic compound having a refractive index of not less than 1.65, preferably not less than 1.9. Examples of inorganic compounds include oxides of Ti, Zn, Sb, Sn, Zr, Ce, Ta, La and In, and complex oxides containing these metal atoms.

Such ultrafine particles may be formed by, for example, treating the particle surface with a surface-treating agent (e.g., a silane coupling agent, Japanese Patent Application Laid-Open Nos. 11-295503, 11-153703 and 2000-9908, or an anionic compound or an organic metal coupling agent, Japanese Patent Application Laid-Open No. 2001-310432), forming a core-shell structure in which high refractive index particles constitute the core (e.g., Japanese Patent Application Laid-Open No. 2001-166104), and using a specific dispersing agent together (Japanese Patent Application Laid-Open No. 11-153703, U.S. Pat. No. 6,210,858 B1, Japanese Patent Application Laid-Open No. 2002-2776069).

The material which constitutes the matrix may be a conventionally known thermoplastic resin or thermosetting resin. The material is preferably at least one composition selected from compositions containing a polyfunctional compound having at least two radically polymerizable groups and/or cationically polymerizable groups, organometallic compounds containing a hydrolyzable group and compositions containing a partial condensate thereof. Examples thereof include compounds described in Japanese Patent Application Laid-Open Nos. 2000-47004, 2001-315242, 2001-31871 and 2001-296401.

A curable film prepared using a colloidal metal oxide obtained from a hydrolyzed condensate of metal alkoxide and a metal alkoxide, composition is also preferred. Such film is described, for example, in Japanese Patent Application Laid-Open No. 2001-293818.

The high refractive index layer has a refractive index of generally 1.70 to 2.20, and a thickness of preferably 5 nm to 10 μm, more preferably 10 nm to 1 μm.

The refractive index of the middle refractive index layer is adjusted so that it is between the refractive index of the low refractive index layer and the refractive index of the high refractive index layer. The middle refractive index layer has a refractive index of preferably 1.50 to 1.70.

### (C-3) Low Refractive Index Layer

The low refractive index layer is stacked on the high refractive index layer. The low refractive index layer has a refractive index of 1.20 to 1.55, preferably 1.30 to 1.50.

This layer is preferably formed as an outermost layer having scratch resistance and an antifouling property. As a means for significantly improving the scratch resistance, imparting lubricity to the surface is effective, and conventionally known methods of forming a thin film layer by introducing silicone or fluorine can be applied.

The refractive index of the fluorine compound is preferably 1.35 to 1.50, more preferably 1.36 to 1.47. Fluorine compounds containing 35 to 80% by mass of fluorine atoms and a cross-linkable or polymerizable functional group are preferable.

Examples of such compound include those described in Japanese Patent Application Laid-Open No. 9-222503, paragraphs [0018] to [0026], Japanese Patent Application Laid-Open No. 11-38202, paragraphs [0019] to [0030], Japanese Patent Application Laid-Open No. 2001-40284, paragraphs [0027] to [0028] and Japanese Patent Application Laid-Open No. 2000-284102.

As the silicone compound, one having a polysiloxane structure and containing a curable functional group or a polymerizable functional group in the polymer chain, and which thus forms a cross-linked structure in the film are preferred. Examples thereof include reactive silicone (e.g., Silaplane, available from CHISSO CORPORATION) and polysiloxane containing a silanol group on both terminals (Japanese Patent Application Laid-Open No. 11-258403).

The cross-linking or polymerization reaction for preparing such fluorine-containing polymer and/or siloxane polymer containing a cross-linkable or polymerizable group is preferably carried out by radiation of light or by heating simultaneously with or after applying a coating composition for forming an outermost layer, which contains a polymerization initiator and a sensitizer.

In addition, a sol-gel cured film obtained by curing an organometallic compound such as a silane coupling agent and a silane coupling agent containing a specific fluorine-containing hydrocarbon group by a condensation reaction in the presence of a catalyst is also preferable.

Examples thereof include silane compounds containing a polyfluoroalkyl group or partially-hydrolyzed condensates thereof (compounds described in Japanese Patent Application Laid-Open Nos. 58-142958, 58-147483, 58-147484, 9-157582, 11-106704) and silyl compounds containing a poly(perfluoroalkyl ether group) which is a long-chain, fluorine-containing group (compounds described in Japanese Patent Application Laid-Open Nos. 2000-117902, 2001-48590, 2002-53804).

The low refractive index layer may contain, in addition to the above components, an additive such as a filler (e.g., silicon dioxide (silica), a low refractive index inorganic compound having an average primary particle size of 1 to 150 nm such as fluorine-containing particles (magnesium fluoride, calcium fluoride, barium fluoride), organic fine particles described in Japanese Patent Application Laid-Open No. 11-3820, paragraphs [0020] to [0038]), a silane coupling agent, a lubricant and a surfactant.

When the low refractive index layer is positioned as the outermost layer, the low refractive index layer may be formed by a gas phase method (vacuum vapor deposition, sputtering, ion plating, or plasma CVD).

The low refractive index layer is preferably formed by coating because inexpensive production is possible.

The low refractive index layer has a film thickness of preferably 30 to 200 nm, more preferably 50 to 150 mm, and most preferably 60 to 120 nm.

### (C-4) Hard Coat Layer

The hard coat layer is formed on the surface of the transparent support in order to impart physical strength to the anti-reflection film. It is particularly preferable to form the hard coat layer between the transparent support and the high refractive index layer.

The hard coat layer is preferably formed by subjecting a curable compound to a crosslinking reaction or polymerization reaction by light and/or heat. The curable functional group is preferably a photopolymerizable functional group, and the organometallic compound containing a hydrolyzable functional group is preferably an organic alkoxysilyl compound. Specific examples of these compounds are the same as those listed in the case of the high refractive index layer.

Specific examples of compositions constituting the hard coat layer include those described in Japanese Patent Application Laid-Open Nos. 2002-144913, 2000-9908 and WO 0/46617.

The high refractive index layer can also serve as a hard coat layer. In such case, a hard coat layer is preferably formed by finely dispersing particles to be incorporated into the hard coat layer using a technique described in the section of the high refractive index layer.

The hard coat layer can also serve as an anti-glare layer having anti-glare function (described later) by adding particles having an average particle size of 0.2 to 10 μm. The film thickness of the hard coat layer can be suitably designed depending on the purpose of use. The hard coat layer has a film thickness of preferably 0.2 to 10 μm, more preferably 0.5 to 7 μm. The strength of the hard coat layer is preferably H or higher, more preferably 2H or higher, and most preferably 3H or higher as measured by the pencil hardness test in accordance with JIS K5400. Further, the smaller the abrasion of a test piece after a taber test in accordance with JIS K5400, the better.

### (C-5) Forward Scattering Layer

A forward scattering layer is provided in order to improve viewing angles when the film is incorporated into a liquid crystal display device and the viewing angle is tilted up, down, to the right and the left. By dispersing fine particles of a different refractive index in the hard coat layer, the forward scattering layer can also have a function of a hard coat layer.

Examples of such layer include those having a specified forward scattering coefficient (Japanese Patent Application Laid-Open No. 11-38208), those in which relative refractive indexes of a transparent resin and fine particles are within specific ranges (Japanese Patent Application Laid-Open No. 2000-199809), and those having a specified haze value of not less than 40% (Japanese Patent Application Laid-Open No. 2002-107512).

### (C-6) Other Layers

In addition to the aforementioned layers, the anti-reflection film may have a primer layer, an anti-static layer, an undercoat layer or a protective layer.

### (C-7) Coating Method

Layers of the anti-reflection film may be formed by coating according to dip coat, air knife coat, curtain coat, roller coat, wire bar coat, gravure coat, micro gravure coat and extrusion coat (described in U.S. Pat. No. 2,681,294).

### (C-8) Anti-Glare Function

The anti-reflection film may have anti-glare function for scattering light from the outside. The anti-glare function can be obtained by creating irregularities on the surface of the anti-reflection film. When the anti-reflection film has anti-glare function, the haze of the anti-reflection film is preferably 3 to 30%, more preferably 5 to 20%, and most preferably 7 to 20%.

As a method of forming irregularities on the surface of the anti-reflection film, any method capable of forming and satisfactorily maintaining such irregularities can be used. For example, a method in which fine particles are used for a low refractive index layer to form irregularities on the film surface (e.g., Japanese Patent Application Laid-Open No. 2000-271878), a method comprising adding a small amount (0.1 to 50% by mass) of relatively large particles (particle size: 0.05 to 2 μm) to the layer (high refractive index layer, middle refractive index layer or hard coat layer) to be formed beneath the low refractive index layer so as to form a film having an irregular surface, and then forming a low refractive index layer thereon with maintaining the surface shape (e.g., Japanese Patent Application Laid-Open Nos. 2000-281410, 2000-95893, 2001-100004 and 2001-281407); and a method comprising applying uppermost layer (anti-fouling layer) and then physically transferring irregularities to the surface thereof (e.g., embossing methods described in Japanese Patent Application Laid-Open Nos. 63-278839, 11-183710 and 2000-275401).

Measurement methods used in the present invention will now be described.

### (Method of Measuring Adhesion Mark)

A sample film is put on a black flat cloth and visually observed with reflected light under a tungsten lamp. Observation of V-shaped marks (like a bird's toenail) of several mm found on the film surface was carried out in an area of 20 m², and the number of the marks was counted and indicated by an average value per 1 m².

### (Method of Measuring Re, Rth, Fluctuation in Re and Rth in Width Direction and Length Direction)

For sampling in the MD direction (length direction), 100 pieces of 1 cm square were cut out in the length direction at intervals of 0.5 m. For sampling in the TD direction (width direction), and 50 pieces of 1 cm square were cut out across the full width of the film at regular intervals. For measuring Re and Rth, the aforementioned sample films were subjected to conditioning at 25° C. and 60% rh for 3 hours or more, and using an automatic birefringence analyzer (KOBRA-21ADH/PR, made by Oji Scientific Instruments), retardation values were measured at 25° C. and 60% rh at a wavelength of 550 nm in a direction perpendicular to the sample film surface, and directions tilted ±40° relative to the normal of the film plane. The in-plane retardation (Re) was calculated from the value in the perpendicular direction, and Rth was calculated from the measured values in the directions tilted ±40° from the perpendicular direction. The average values of all sampling points were defined as Re and Rth.

The difference between the maximum value and the minimum value of 100 points in the MD direction and 50 points in the TD direction was divided by each average value and shown in percentage to be defined as fluctuation in Re and fluctuation in Rth.

### (Degree of Substitution of Cellulose Acylate)

The acyl substitution degree of cellulose acylate was measured using 13C-NMR according to the method described in Carbohydr. Res. 273 (1995) 83-91 (Tezuka et al.).

### Example

### 1. Thermoplastic Resin

### (1) Cellulose Acylate

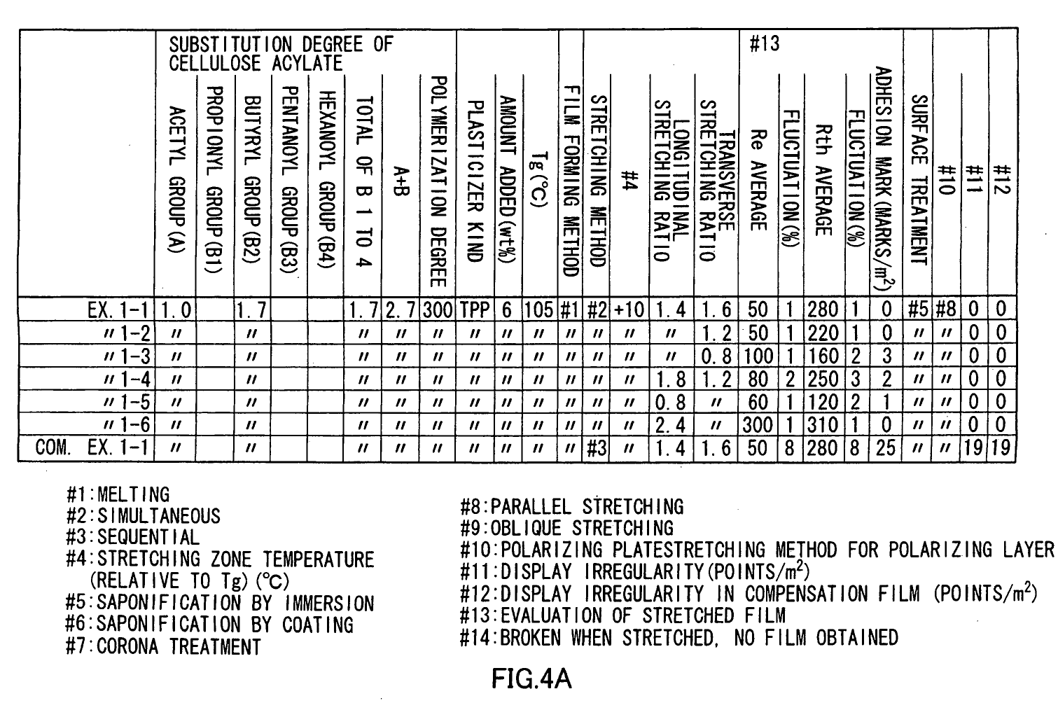

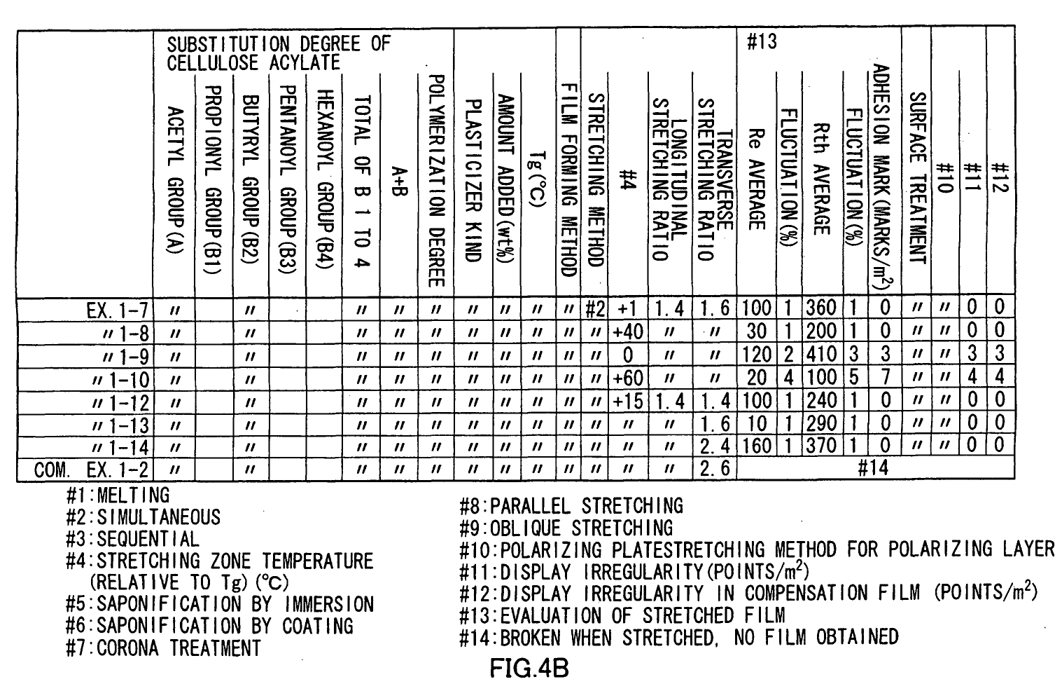

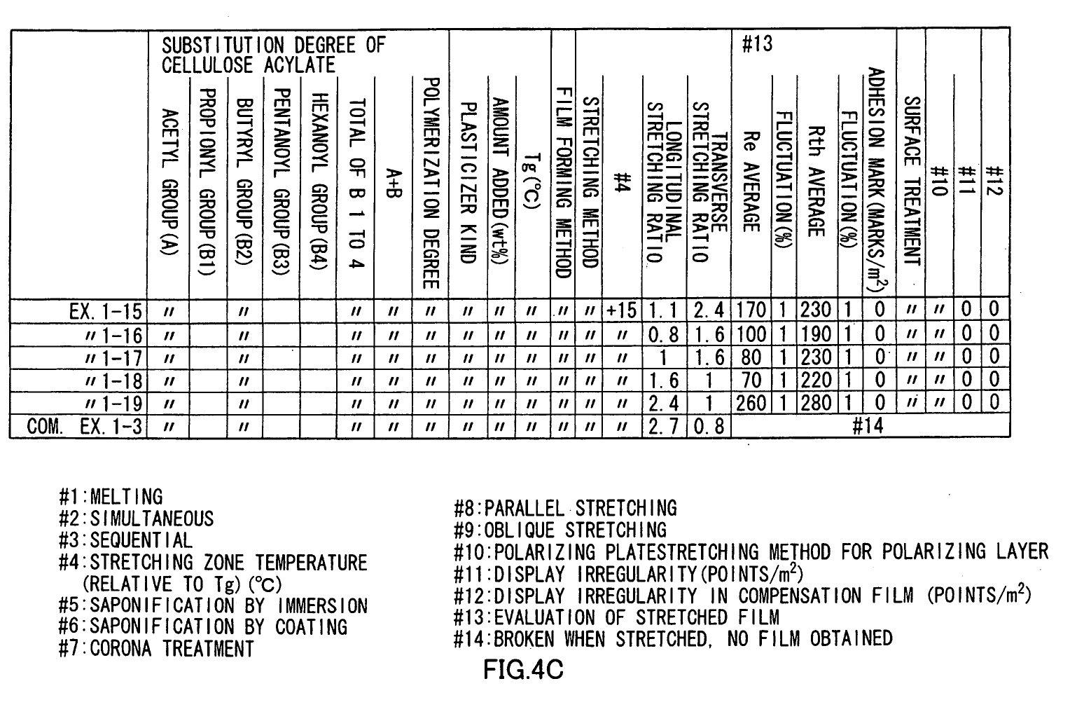

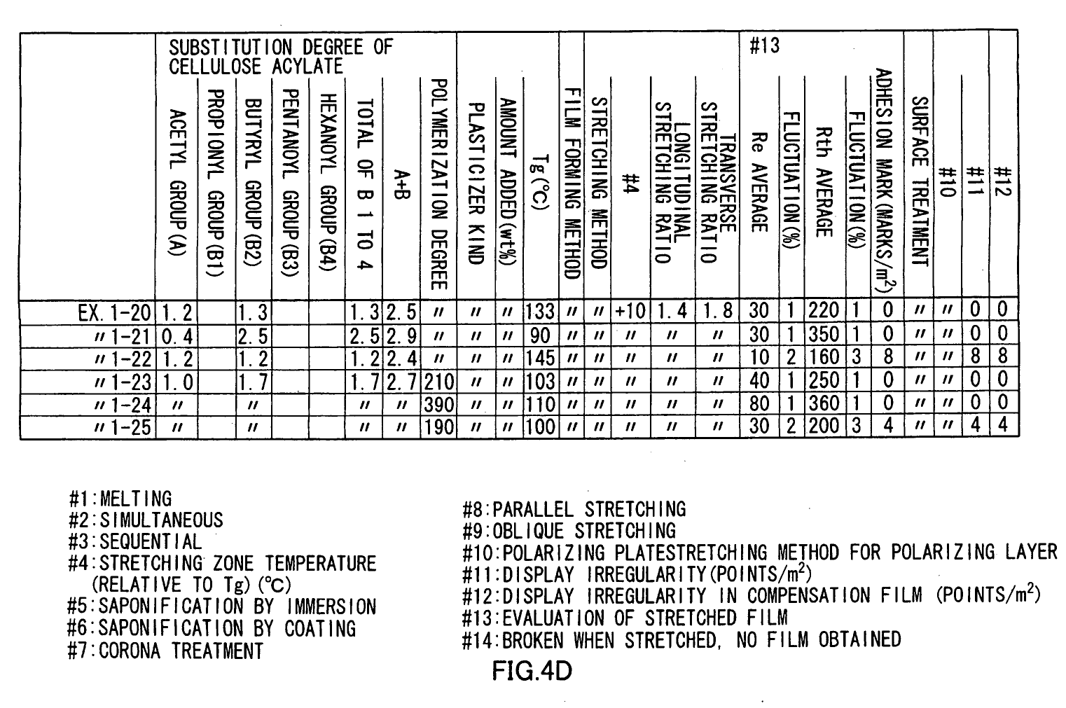

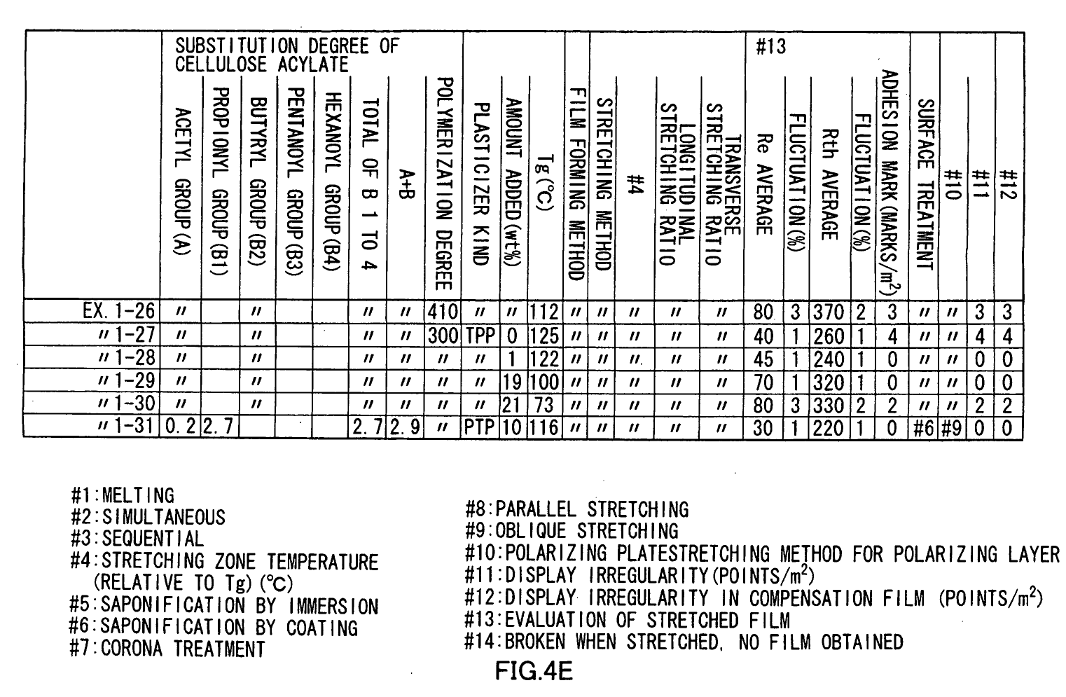

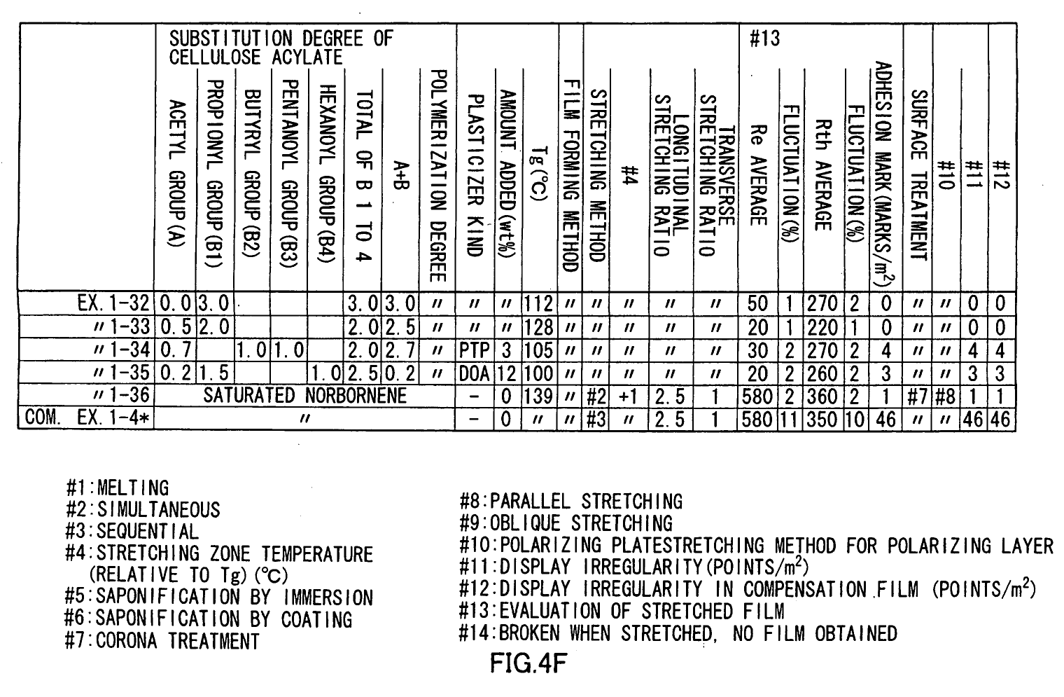

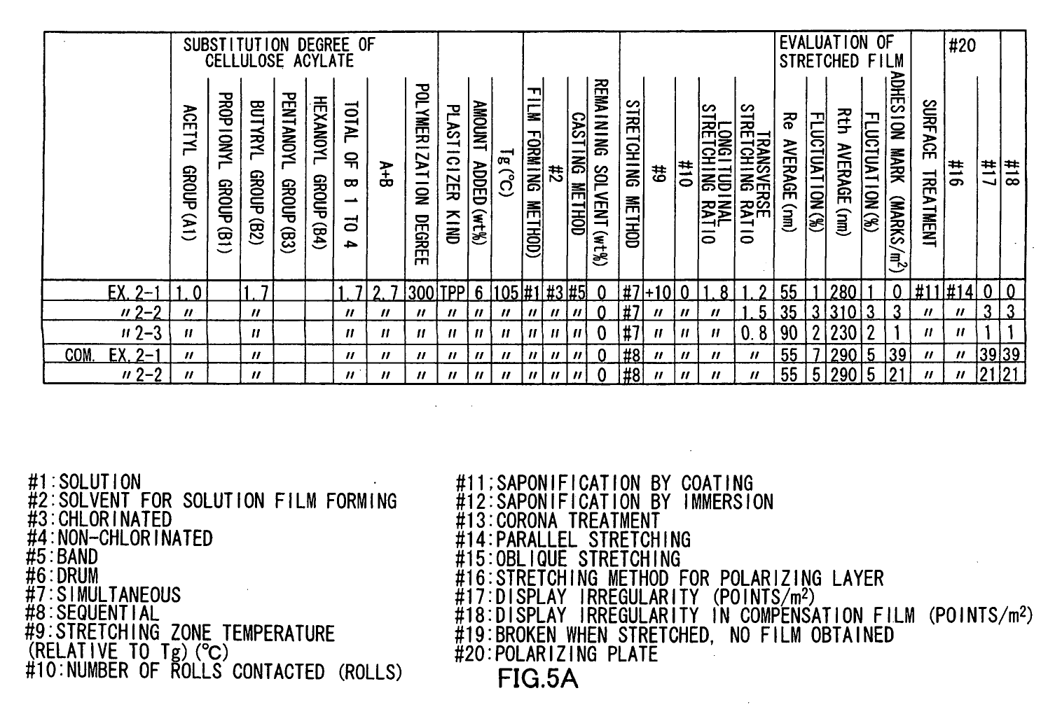

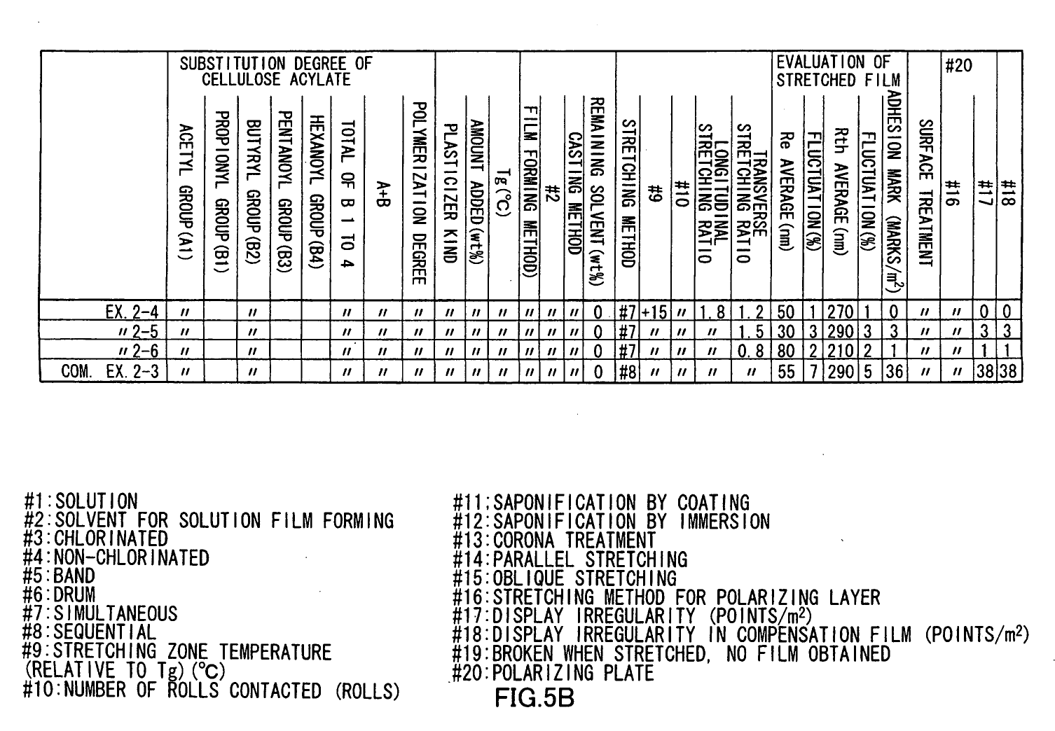

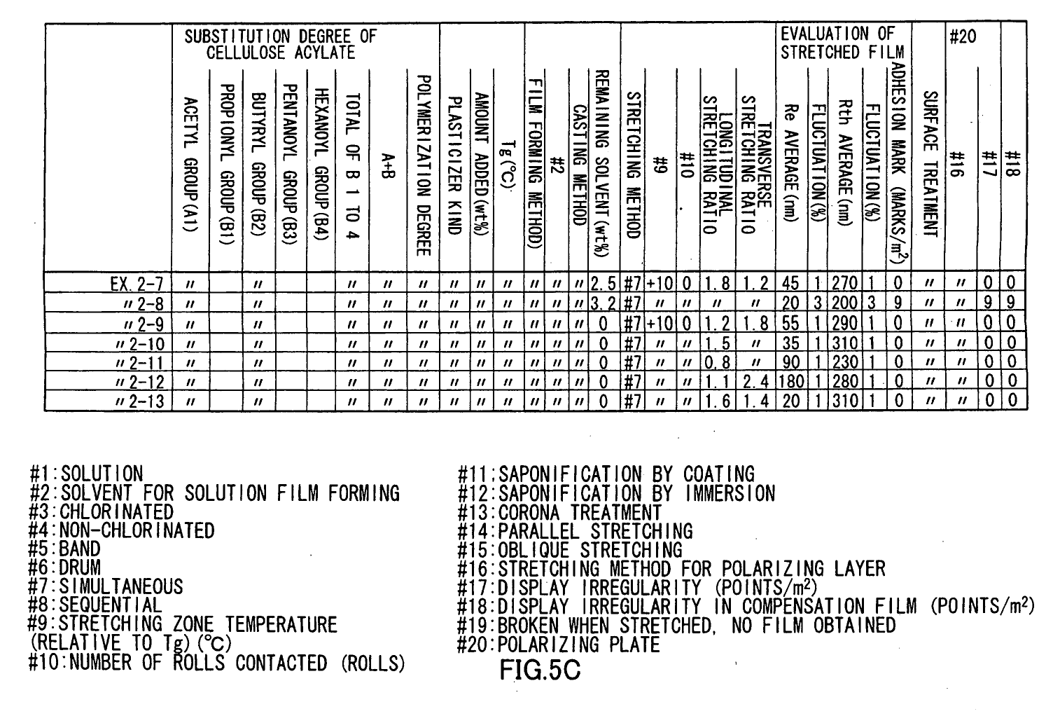

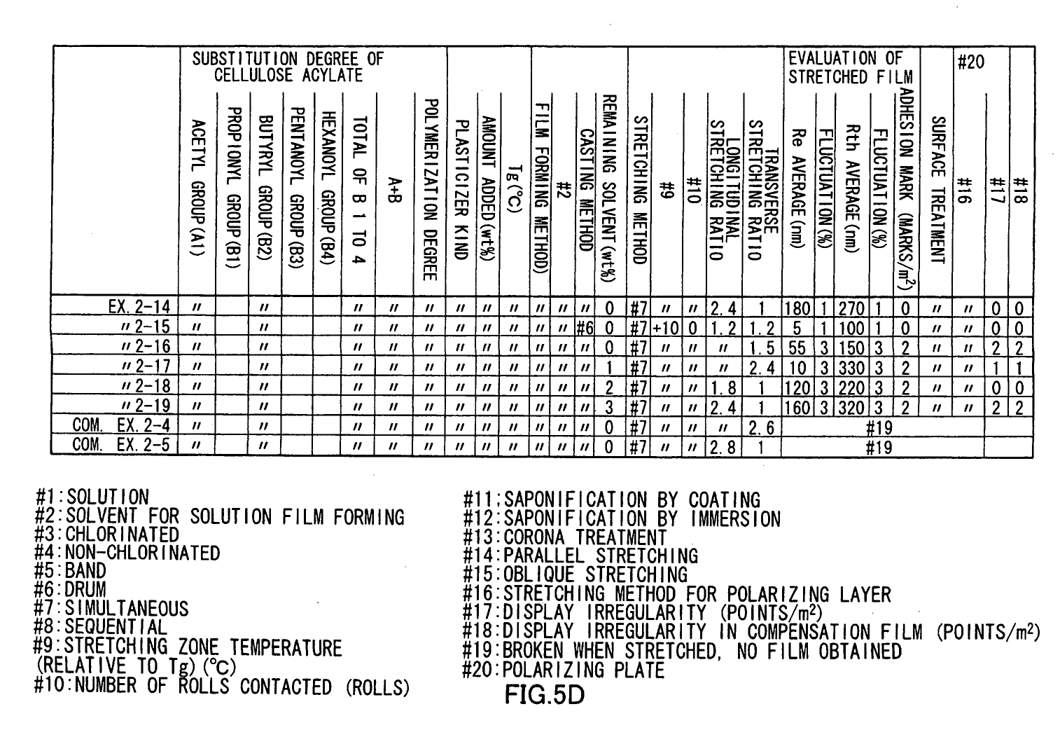

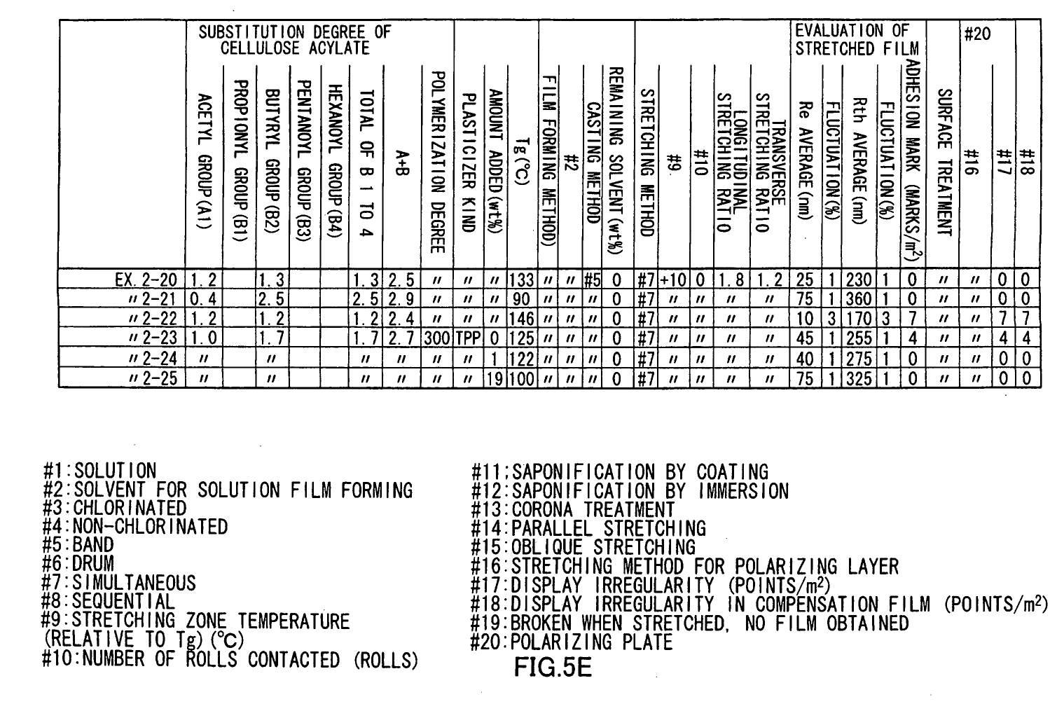

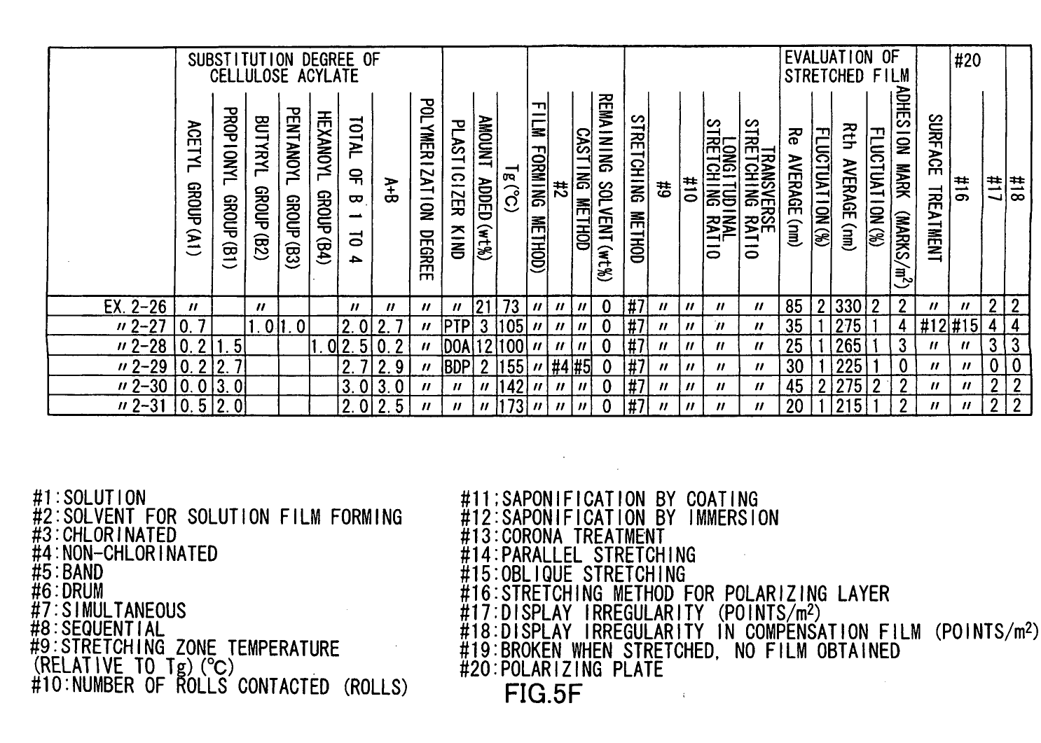

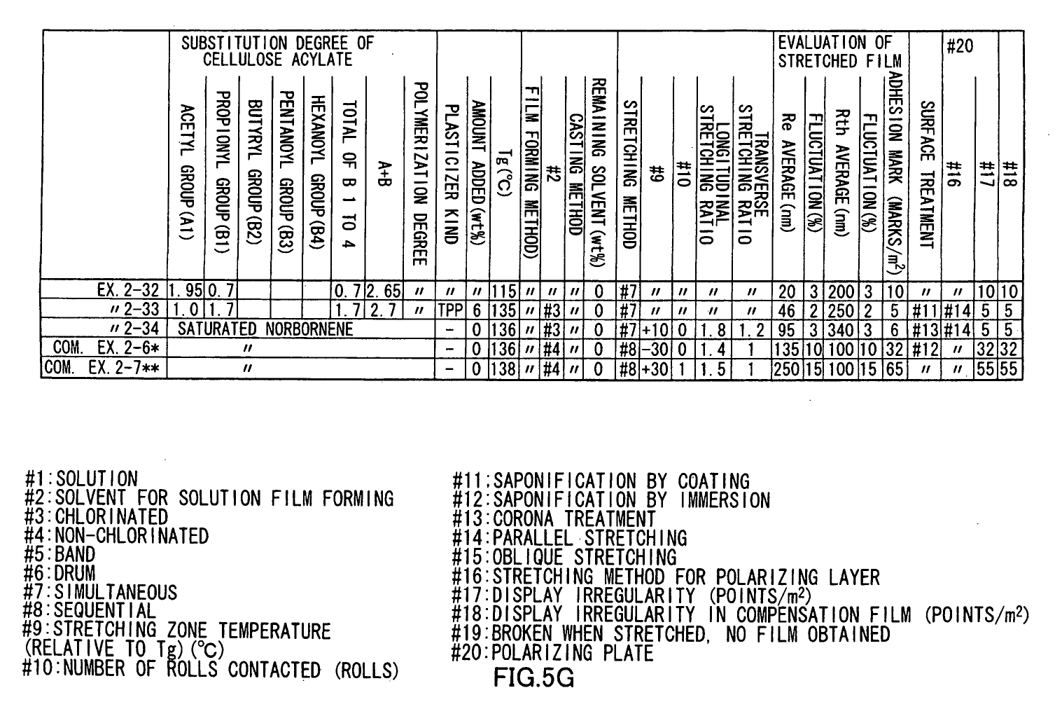

Cellulose acylates having different acyl groups and different substitution degrees as shown in Table 1 (FIGS. 4A to 4F) were prepared. Specifically, sulfuric acid (7.8 parts by weight based on 100 parts by weight of cellulose) was added as a catalyst and carboxylic acid which is the raw material of acyl substituent was added to conduct an acylation reaction at 40° C. Based on the kind and the amount of carboxylic acid, the kind and the substitution degree of the acyl group were controlled. After acylation, the resultant was ripened at 40° C. The polymerization degrees of the cellulose acylates thus obtained were determined by the following method and are shown in Tables 1 and 2 (FIGS. 4A to 4F, and FIGS. 5A to 5G).

### (Method of Measuring Polymerization Degree)

Completely dried cellulose acylate was precisely weighed in an amount of about 0.2 g and dissolved in 100 ml of a mixed solvent of methylene chloride:ethanol 9:1) (mass ratio). The dropping time in seconds of the mixture was measured using an Ostwald viscometer at 25° C. and the polymerization degree was calculated according to the following formula.

ηrel=T/T0

[η]=(1nηrel)/C

DP=[η]=/Km

In the formula, T: dropping time in seconds of measurement sample, T0: dropping time in seconds of solvent alone, C: concentration (g/l), and Km: 6×10⁻⁴.

Tg was measured by the following method and shown in Tables 1 and 2. For those to which a plasticizer was added, values measured after adding the plasticizer are shown.

(Measurement of Tg) 20 mg of a sample was put in a DSC pan. The sample was heated from 30° C. to 250° C. at 10° C./minute under nitrogen stream (1st run), and then cooled to 30° C. at −10° C./minute. The sample was then heated again from 30° C. to 250° C. (2nd run). The temperature at which the baseline starts to deflect from the low temperature side in the 2nd run is defined as a glass transition temperature (Tg) and shown in Tables 1 and 2. In addition, 0.05% by mass of silicon dioxide fine particles (AEROSIL R1972V) were added to all samples.

### (2) Saturated Norbornene Resin

To 6-methyl-1,4,5,8-dimethano-1,4,4a,5,6,7,8,8a-octahydronaphthalene were added 10 parts of a 15% triethylaluminum cyclohexane solution as a polymerization catalyst, 5 parts of triethylamine and 10 parts of a 20% titanium tetrachloride cyclohexane solution to carry out ring-opening polymerization in cyclohexane. The polymer obtained by ring-opening polymerization was hydrogenated with a nickel catalyst to prepare a polymer solution. The polymer solution was agglomerated in isopropyl alcohol and dried to give a powdery resin. The number average molecular weight of the resin was 40000, the hydrogenation degree was 99.8% or more and the Tg was 139° C.

### (3) Polycarbonate Resin (PC Resin)

PC resin modified by 9,9-bis(3-methyl-4-hydroxyphenyl)fluorene was produced according to Example 1 of Japanese Patent Application Laid-Open No. 2003-29040. The Tg of the PC resin was 215° C.

### 2. Film Forming

### (1) Melt Film Forming

The cellulose acylates and the saturated norbornene resin described above were formed into cylindrical pellets 3 mm in diameter and 5 mm in length. At this time, plasticizers were selected from those described later (shown in Table 1) and mixed with the pellet. The resultant was dried in a vacuum dryer at 110° C. and after controlling the moisture content to 0.1% or less, this was introduced to the hopper adjusted to Tg-10° C.

In Table 1, TPP: triphenyl phosphate, BDP: biphenyldiphenyl phosphate, DOA: bis(2-ethylhexyl)adipate, PTP: 1,4-phenylene-tetraphenyl phosphoric ester.

The melting temperature was adjusted so that the melt viscosity was 5000 Pα·s, and after carrying out melting for 5 minutes using a single screw kneader, the melted material was cast on a casting drum adjusted to Tg−5° C. through a T-die adjusted to 10° C. higher than the melting temperature and solidified to form a film. At this stage, an electrostatic application method was used for each sample (10 kV wire being placed 10 cm from the landing point of the melt on the casting drum). The solidified melt was peeled off and taken up. Immediately before taking, both ends were trimmed (3% each of the total width) and subjected to thickness increasing processing (knurling) to achieve ) a width of 10 mm and a height of 50 μm. All samples were taken up at 30 m/minute in a width of 1.5 m and in a length of 3000 m.

### (2) Solution Film Forming

### (Cellulose Acylate)

### (A) Charging

After drying the aforementioned cellulose acylate resins to a moisture content of 0.1 wt % or less, plasticizers shown in Table 1 were added and the mixture was dissolved using a solvent selected from the following so that the proportion of the cellulose acylate was 25% by weight.
non-chlorinated solvent: methyl acetate/acetone/methanol/ethanol/butanol (80/5/7/5/3, parts by mass)
chlorinated solvent: dichloromethane/methanol/ethanol/butanol (85/6/5/4, parts by mass)

Plasticizers were selected from the aforementioned TPP, BDP, DOA and PTP and shown in Table 2 (FIG. 5A to 5G). In addition to these, the following additives were added to each sample.
optical anisotropy controlling agent: plate-like compound (3 wt %) described in Formula I of Japanese Patent Application Laid-Open No. 2003-66230
UV agent a: 2,4-bis-(n-octylthio)-6-(4-hydroxy-3,5-di-tert-butylanilino)-1,3,5-triazine (0.5 wt %)
UV agent b: 2(2′-hydroxy-3′,5′-di-tert-butylphenyl)-5-chlorobenzotriazole (0.2 wt %)
UV agent c: 2(2′-hydroxy-3′,5′-di-tert-amylphenyl)-5-chlorobenzotriazole (0.1 wt %)
fine particle: silicon dioxide (particle size 20 nm), Mohs hardness about 7 (0.25 wt %)
citric acid ethyl ester (monoester and diester being mixed at 1:1, 0.2 wt %)

The aforementioned amounts to be added (wt %) are all based on the amount of cellulose acylate.

### (B) Swelling, Dissolution

The cellulose acylate and additives were added to the solvent with stirring. After completion of the addition, stirring was stopped and the mixture was swelled at 25° C. for 3 hours to prepare a slurry. The slurry was stirred again to completely dissolve the cellulose acylate.

### (C) Filtration, Concentration

The resultant was then filtrated using a filter of an absolute filtration accuracy of 0.01 mm (available from Toyo Roshi Kaisha, Ltd., #63), and further using a filter of an absolute filtration accuracy of 2.5 μm (available from Pall Corporation, FH025).

### (D) Film Forming

The aforementioned dope was heated to 35° C. and cast by either of the following methods (described in Table 2).

### (D-1) Band Method

The dope was cast on a mirror finished stainless steel support of a band length of 60 m, which was set to 15° C., through a casting die. As the die head, one with a form similar to that described in Japanese Patent Application Laid-Open No. 11-314233 was used. The casting speed was 60 m/minute and the casting width was 250 cm.

A film obtained from the cast dope was peeled from the support when the amount of remaining solvent was 100 wt %, and after drying at 130° C., the film was wound up when the amount of remaining solvent was as described in Table 2, whereby a cellulose acylate film was obtained. The both ends of the obtained film was trimmed by 3 cm and knurling in a height of 100 μm was performed at a portion 2 to 10 mm from the ends and the film was rolled up in a length of 3000 m.

### (D-2) Drum Method

The dope was cast on a mirror finished stainless steel drum of a diameter of 3 m, which was set to −15° C., through a casting die. The die was of a form similar to that described in Japanese Patent Application Laid-Open No. 11-314233. The casting speed was 100 m/minute and the casting width was 250 cm.

A film obtained from the cast dope was peeled from the drum when the amount of remaining solvent was 200 wt %, and after drying at 130° C., the film was wound up when the amount of remaining solvent was as described in Table 2, whereby a cellulose acylate film was obtained. The both ends of the obtained film was trimmed by 3 cm and knurling in a height of 100 μm was performed at a portion 2 to 10 mm from the ends and the film was rolled up in a length of 3000 m.

### (PC: Polycarbonate)

PC resin was dissolved in dichloromethane to be 19 wt % according to Example 1 of Japanese Patent Application Laid-Open No. 2003-29040. The resultant dope was extruded through a T-die on a band. When the remaining solvent reached 35 wt %, a film-like object obtained from the dope was peeled from the band and then subjected to stretching.

### 3. Stretching

### (Simultaneous Biaxial Stretching)

The thermoplastic films obtained by the melt film forming and the solution film forming described above were stretched under the conditions described in Table 2 with volatile components still remaining therein. The stretching temperature is indicated in Table 1 “relative to Tg”, that is, indicated by how much higher or lower than the Tg of the material of each sample (Tg of those containing plasticizer being measured in that state) in a temperature indication of + or −. The evaluation results of the stretched films obtained as described above are shown in Tables 1 and 2. The Re, Rth (average values), the orientation angle and their coefficient of fluctuation of the thus-obtained films were measured according to the aforementioned method and the results are shown in Tables 1 and 2. Adhesion unevenness was also measured according to the aforementioned method and the results are shown in Tables 1 and 2.

### 4. Preparation of Polarizing Plate

### (1) Surface Treatment

### (1-1) Cellulose Acylate Film

The cellulose acylate film after stretching was subjected to either of the following saponification methods and the method employed was shown in Tables 1 and 2.

### (a) Saponification by Coating

To 80 parts by weight of iso-propanol was added 20 parts by weight of water and KOH was dissolved therein to be 1.5N. The obtained mixture was adjusted to 60° C. to be used as a saponifying solution. The solution was applied to the cellulose acylate film at 60° C. at 10 g/m² to carry out saponification for 1 minute. Subsequently, hot water at 50° C. was sprayed using a spray at 101 m²-minute for 1 minute to wash the film.

### (b) Saponification by Immersion

A 1.5N NaOH aqueous solution was used as a saponifying solution. The solution was adjusted to 60° C., in which the cellulose acylate film was immersed for 2 minutes. The cellulose acylate film was then immersed in a 0.1N sulfuric acid aqueous solution for 30 seconds and passed through a wash bath.

### (1-2) Saturated Norbornene Film, PC Film

Films were subjected to surface corona treatment so that the contact angle of the surface with water was 60 degrees.

### (2) Preparation of Polarizing Layer

A polarizing layer 20 μm in thickness was prepared according to either of the following methods (described in Tables 1 and 2). In the present invention, a film to which polarizing ability is given by stretching is referred to as a polarizing layer, while one in which such polarizing layer is sandwiched by at least two protective films or retardation films is referred to as a polarizing plate to distinguish the two.

### (a) Oblique Stretching

According to Example 1 of Japanese Patent Application Laid-Open No. 2002-86554, a film was stretched using a tenter so that the stretching axis was at an oblique angle of 45 degrees.

### (b) Parallel Stretching

According to Example 1 of Japanese Patent Application Laid-Open No. 2001-141926, a film was stretched in the length direction with differentiating peripheral speeds of two pairs of nip rolls.

### (3) Adhesion

The thus-obtained polarizing layer was sandwiched by the aforementioned saponified stretched thermoplastic film (retardation plate) and saponified polarizing plate protective film (commercial name: FUJITAC). At this time, the retardation plate and the polarizing layer were adhered using a 3% aqueous solution of PVA (PVA-117H available from Kuraray Co., Ltd.) as an adhesive when the retardation plate is made of cellulose acylate, or an epoxy adhesive when the retardation plate is made of other materials. The film of FUJITAC and the polarizing layer were adhered using the aforementioned PVA aqueous solution as an adhesive. The direction of adhesion was adjusted so that the polarization axis and the length direction of the retardation plate form an angle of 45 degrees. The thus obtained polarizing plate was incorporated into a 20 inch VA-type liquid crystal display device illustrated in FIGS. 2 to 9 of Japanese Patent Application Laid-Open No. 2000-154261 with setting the retardation plate on the liquid crystal side and the FUJITAC film on the outer side (viewing side), and occurrence of display irregularities per unit area was visually observed, the result of which is shown in Tables 1 and 2. The films to which the present invention was applied had uniform and excellent properties.

### 5. Preparation of Compensation Film

When a stretched thermoplastic film of the present invention was used instead of the cellulose acetate film of Example 1 of Japanese Patent Application Laid-Open No. 11-316378 to which a liquid crystal layer is applied, an excellent compensation film was prepared.

When a stretched thermoplastic film of the present invention was used instead of the cellulose acetate film of Example 1 of Japanese Patent Application Laid-Open No. 7-333433 to which a liquid crystal layer is applied to prepare a compensation filter film, an excellent compensation film was prepared.

On the other hand, those outside the range of the present invention had decreased optical properties. In particular, those according to Example 1 of Japanese Patent Application Laid-Open No. 2002-311240 (Comparative Example 1-4 in Table 1), those according to sample No. S-11 in the Examples of Japanese Patent Application Laid-Open No. 2003-315551 (Comparative Example 2-4 in Table 2) and those according to Example 1 of Japanese Patent Application Laid-Open No. 2001-42130 (Comparative Example 2-5 in Table 2) had significant deterioration in optical properties.

### 6. Preparation of Low Reflection Film

When a low reflection film was prepared using the stretched thermoplastic film of the present invention according to Example 47 of “Kokai Giho of Japan Institute of Invention & Innovation” (Kogi No. 2001-1745), uniform and excellent optical properties were obtained.

### 7. Preparation of Liquid Crystal Device

The aforementioned polarizing plate of the present invention was applied to the liquid crystal display device described in Example 1 of Japanese Patent Application Laid-Open No. 10-48420, the optically anisotropic layer containing discotic liquid crystal molecules described in Example 1 of Japanese Patent Application Laid-Open No. 9-26572, an alignment film coated with polyvinyl alcohol, the 20 inch VA-type liquid crystal display device described in FIGS. 2 to 9 of Japanese Patent Application Laid-Open No. 2000-154261, and the 20 inch OCB-type liquid crystal display device described in FIGS. 10 to 15 of Japanese Patent Application Laid-Open No. 2000-154261. Further, the low reflection film of the present invention was applied to the outermost layer of these liquid crystal display devices and the devices were subjected to evaluation. As shown in Tables 1 and 2, uniform and excellent liquid crystal display devices without display irregularities due to adhesion marks were obtained.

### 8. Result

Table 1 shows the results of stretching of films obtained by melt film forming. Referring to Table 1, in Examples 1-1 to 6 where simultaneous biaxial stretching of cellulose acylate film was carried out, films whose Re, Rth, and adhesion marks are within appropriate ranges were produced. On the contrary, in Comparative Example 1-1, because sequential biaxial stretching was carried out, the coefficient of fluctuation in Re and that in Rth were increased and the number of adhesion marks was also increased, falling to inappropriate ranges.

Examples 1-7 to 10 were carried out with change in the temperature in the stretching zone. Examples 1-12 to 14 were carried out with change in the stretching ratio in the transverse direction, and Example 1-19 was carried out with change in the stretching ratio in the longitudinal direction. Films with appropriate ranges of Re, Rth and adhesion marks were obtained in these Examples as well, because the simultaneous biaxial stretching was carried out. However, in Comparative Examples 1-2 and 3 in which the stretching ratio is more than 2.5 times, the film was broken when stretched and a film product was not obtained.

Examples 1-20 to 35 were carried out at different substitution degrees, all of which produced good results. In particular, in the range in which the substitution degree B satisfies 1.25 to 3.0 and the substitution degree A+B satisfies 2.5 to 3.0, excellent results were obtained.

In Example 1-36 and Comparative Example 1-4, saturated norbornene films were stretched. In these cases as well, good results were obtained when simultaneous biaxial stretching was carried out, while the film produced by sequential biaxial stretching was defective.

Table 2 shows the results of stretching of films obtained by solution film forming. As shown in Table 2, although Examples 2-1 to 34 were carried out with change in the temperature of the stretching zone, the longitudinal stretching ratio, the transverse stretching ratio, the substitution degree and the kind of film, excellent films were obtained because simultaneous biaxial stretching was carried out.

On the contrary, Comparative Examples 2-1 to 3, 6 and 7 in which sequential biaxial stretching was carried out suffered from disadvantages of increased adhesion marks and increased display irregularities. Further, in Comparative Examples 2-4 and 5 in which the stretching ratio is more than 2.5 times, the film was broken when stretched and a film product was not obtained.

1. A method of producing a thermoplastic film including stretching a thermoplastic film, comprising the step of:
simultaneously stretching the film in the longitudinal direction and the transverse direction to produce a thermoplastic film having adhesion marks equal to or less than 10 marks/m², and having an in-plane retardation Re of 0 nm to 500 nm and a retardation Rth in the thickness direction of 30 nm to 500 nm.

2. The method of producing a thermoplastic film according to claim 1, wherein the stretching ratio in the longitudinal direction and the transverse direction is 1 to 2.5.

3. The method of producing a thermoplastic film according to claim 1, wherein the stretching ratio in one of the longitudinal direction and the transverse direction is 0.8 to 1.0, and the stretching ratio in the other direction is 1.0 to 2.5.

4. The method of producing a thermoplastic film according to claim 1, further comprising the step of holding both ends of the film in the width direction with a clip during stretching of the film.

5. (canceled)

6. (canceled)

7. (canceled)

8. (canceled)

9. (canceled)

10. (canceled)

11. (canceled)

12. The method of producing a thermoplastic film according to claim 2, further comprising the step of holding both ends of the film in the width direction with a clip during stretching of the film.

13. The method of producing a thermoplastic film according to claim 3, further comprising the step of holding both ends of the film in the width direction with a clip during stretching of the film.

14. A thermoplastic film, wherein the film has the following properties:
(A) has adhesion marks equal to or less than 10 marks/m²;
(B) has an in-plane retardation Re of 0 m to 500 nm; and
(C) has a retardation Rth in the thickness direction of 30 nm to 500 nm.

15. The thermoplastic film according to claim 14, wherein the fluctuation in the retardation Re and the retardation Rth is 5% or less in the width direction and in the length direction.

16. The thermoplastic film according to claim 14, which is a cellulose acylate film or a norbornene resin film.

17. The thermoplastic film according to claim 15, which is a cellulose acylate film or a norbornene resin film.

18. The thermoplastic film according to claim 16, wherein the cellulose acylate film satisfies a degree of substitution of acylate groups of 2.5≦A+B<3.0 and 1.25≦B<3.0 (A: degree of substitution of acetyl groups, B: total degree of substitution of propionyl groups, butyrate groups, pentanoyl groups and hexanoyl groups).

19. The thermoplastic film according to claim 17, wherein the cellulose acylate film satisfies a degree of substitution of acylate groups of 2.5≦A+B<3.0 and 1.25≦B<3.0 (A: degree of substitution of acetyl groups, B: total degree of substitution of propionyl groups, butyrate groups, pentanoyl groups and hexanoyl groups).

20. A polarizing plate comprising at least one layer of a cellulose acylate film according to 16 stacked therein.

21. A polarizing plate comprising at least one layer of a cellulose acylate film according to claim 19 stacked therein.

22. A compensation film for a liquid crystal display, comprising a cellulose acylate film according to claim 16 as a substrate.

23. A compensation film for a liquid crystal display, comprising a cellulose acylate film according to claim 19 as a substrate.

24. An anti-reflection film comprising a cellulose acylate film according to claim 16 as a substrate.

25. An anti-reflection film comprising a cellulose acylate film according to claim 19 as a substrate.
